(19) United States
(12) Patent Application Publication
(10) Pub. No.: US 2002/0032626 A1
(43) Pub. Date: Mar. 14, 2002

(54) Global asset information registry

(76) Inventors: Frederik M. DeWolf, Ithaca, NY (US); Steven Lutter, Trumansburg, NY (US); Gregory C. Flickinger, Furlong, PA (US); Charles A. Eldering, Doylestown, PA (US)

Correspondence Address: Douglas J Ryder, Technology Patents and Licensing Inc, 340 North Broad Street, Doylestown, PA, 18901, US

(21) Appl. No.: 09/740,568

(22) Filed: May 2, 2001

Related U.S. Application Data
(60) Provisional application No. 60/172,397, filed on Dec. 17, 1999.

(51) Int. Cl. G06F 17/60

(52) U.S. Cl. 705/35; 705/36

(57) ABSTRACT

Recording information related to an asset in an asset registry throughout the life cycle of the asset. Categorizing the information into multiple attributes. Managing read and write privileges to the asset registry for various entities having an interest in the asset. Providing access to the attributes to the various entities that have an interest in the asset. Entities having write privileges can write information to the asset registry, and entities having read privileges can read information from the asst registry.

The present application claims the priority of U.S. Provisional Patent Application No. 60/172,397, filed on Dec. 17, 1999, which is herein incorporated by reference in its entirety.

### BACKGROUND OF THE INVENTION

Current business practice regarding asset inventories consist of several different methods of creating and maintaining those inventories. These methods vary greatly and are not consistent from either industry to industry or government agency to government agency or entity-to-entity.

In a traditional asset management system, an entity desiring to manage information about a type or group of assets creates an asset management database comprising particular information, according to the user's needs, about each asset being managed. The asset management database must then be maintained to keep the asset information current. Depending upon the information maintained for the asset, this could entail a manual entry, a bar code scan, or a combination for each transaction effecting the status of each asset.

Frequently, an asset will be included in multiple asset management databases, for different entities or for different information. For example, an automobile manufacturer might maintain an asset management database for customer service, while a government entity might maintain an asset management database for automobile registration and an insurance company might maintain an asset management database for automobile insurance. Also, an automobile manufacturer might have an asset management database for supply chain management and a separate asset management database for customer service.

Different industries frequently use different procedures for creating asset inventories (e.g., asset management databases). In the insurance industry, an asset owner wishing to insure that asset must typically complete a variety of forms and present related documents to prove ownership of the asset and to identify the asset as a unique entity. Additional legal documents may be required to authenticate the status or value of the asset, such as surveys, titles, deeds, and appraisals. In corporate record keeping, assets are typically entered manually into an asset database, which can range from a stand-alone system to a networked database.

Several approaches to creating a computer-based inventory system are utilized. Insurers, producers, asset owners, and other organizations typically develop proprietary systems, purchase vendor solutions, or out source entirely required asset tracking. These asset-tracking systems frequently are unable to communicate or share information. Typically, after a transfer of ownership of an asset, prior information about an asset is lost.

A need still exists for an efficient method for asset and information management where data is not lost after a transfer of ownership. A need also exists for an asset and information management system where different organizations having an interest in the same asset can share information concerning that asset. A further need exists for an asset and information management system that can accommodate transactions concerning assets within the system.

### SUMMARY OF THE INVENTION

The present invention provides a method and system for attributing ownership of an asset or property to an individual, groups of individuals or other entities, as well as maintaining an up-to-date status regarding relevant attributes of the asset. In one embodiment of the present invention, a single interoperable database would comprise all possible forms of ownership and other attributes regarding each asset. The database would be broadly available across computer networks, such as the Internet, and would provide for interfaces with commonly used computer applications, such as Internet Browsers. In this embodiment, the registry would allow for all forms of individuals or organizations to participate in the registry. This includes participation not only of owners, producers, sellers, financiers, and insurers, but also allows for participation of organizations that have an interest in asset ownership and other attributes, including law enforcement agencies, courts of law, legislative bodies, and regulatory agencies. The registry would provide for methods of conducting transactions that alter the state of ownership and other attributes of the asset. The system would also generate and incorporate documentation related to the above.

The present invention relates to networked computer systems and methods for asset registration and for conducting business (e.g. across a network) regarding the assets. More particularly, this invention relates to systems and methods that together or separately, facilitate (both automated and non-automated) asset registration, record keeping, transaction processing, and other functionality related to ownership rights and other attributes related to assets.

The present invention relates to, among other things, a computer system consisting of computers and a communications network and related software as well as a method of conducting business across a computer network. More particularly, a preferred embodiment of the invention relates to systems and methods that together, facilitate record keeping and transaction processing related to asset ownership and other attributes. One embodiment allows for distribution of Digital Objects which are classified as Assets or as Documents related to the same, as well as for the integration of conducting financial and other transactions relating to the same (e.g., royalties, options, debt financing, credit services as well as direct payment).

A Global Asset Information Registry (GAIR) is maintained and accessed by the asset owners and by any combination of organizations and individuals having a relationship to these assets. GAIR is meant to include all means, forms, functions, methods, etc. related to asset registration, and is not limited to “global” registration, but may in some of the multitude of embodiments, relate to specific assets or asset classes and specific classes of interested entities which may have one or more relations to the asset(s). It is envisioned that there may be many variations of GAIRs, existing simultaneously, in some cases independent and in other cases inter-dependent of one another. A single global GAIR is of course also possible.

Ownership and other attributes of “objects,” including digital objects may be captured in a single, inter-operable database or in multiple and distinct databases or both. A GAIR contains, among other data, data regarding the object, producer, the owner and other agencies or individuals with a stockholder's interest in the same.

The system allows for, among other things, the exchange of ownership rights and other asset related transactions. The system would facilitate various methods of exchange, e.g., monies in exchange for objects, barter, auctions, as well as gifting. It also accounts for decommissioning or destruction of the object.

In one embodiment, a GAIR may be organized around attributes that describe individuals and their relationships to those objects as well as attributes of all known objects. This GAIR allows for relationships of objects (parts) to other objects (systems or complex objects consisting of various parts) and for relationships between individuals and other individuals, or groups of individuals.

In one embodiment, the asset registry would be broadly accessible across an electronic network. This would be accomplished, in part, through the use of generic or common software tools such as WWW browsers, Web Servers and Internet Transfer Protocols or other like computers and networks. Other such broadly accessible solutions are possible as will be evident to those skilled in the art.

One aspect of the present invention represents a unique approach to incorporating various aspects of current business methods into an approach that mitigates the weaknesses and faults in current practices. One aspect of the invention first and foremost offers a single strategy that allows for the record of ownership of assets to be developed, transferred and accessible in a standardized format using a standardized approach.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates an exemplary system architecture of a global asset information registry (GAIR), according to one embodiment of the present invention;

FIG. 2 illustrates an exemplary UML class diagram, according to one embodiment of the present invention;

FIG. 3 illustrates an exemplary UML class diagram, according to one embodiment of the present invention;

FIG. 4 illustrates an exemplary UML class diagram, according to one embodiment of the present invention;

FIG. 5 illustrates an exemplary UML use case diagram, according to one embodiment of the present invention;

FIG. 6 illustrates an exemplary UML activity diagram showing the activities associated with asset creation, according to one embodiment of the present invention;

FIG. 7 illustrates an exemplary UML activity diagram showing the activities associated with third party access, according to one embodiment of the present invention;

FIG. 8 illustrates an exemplary UML use case diagram for a multi-vender GAIR, according to one embodiment;

FIG. 9 illustrates an exemplary master record of a multi-vendor GAIR, according to one embodiment; and

FIG. 10 illustrates an exemplary master record of a real-property GAIR, according to one embodiment.

### DETAILED DESCRIPTION OF THE PREFERRED EMBODIMENTS

In describing a preferred embodiment of the invention illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

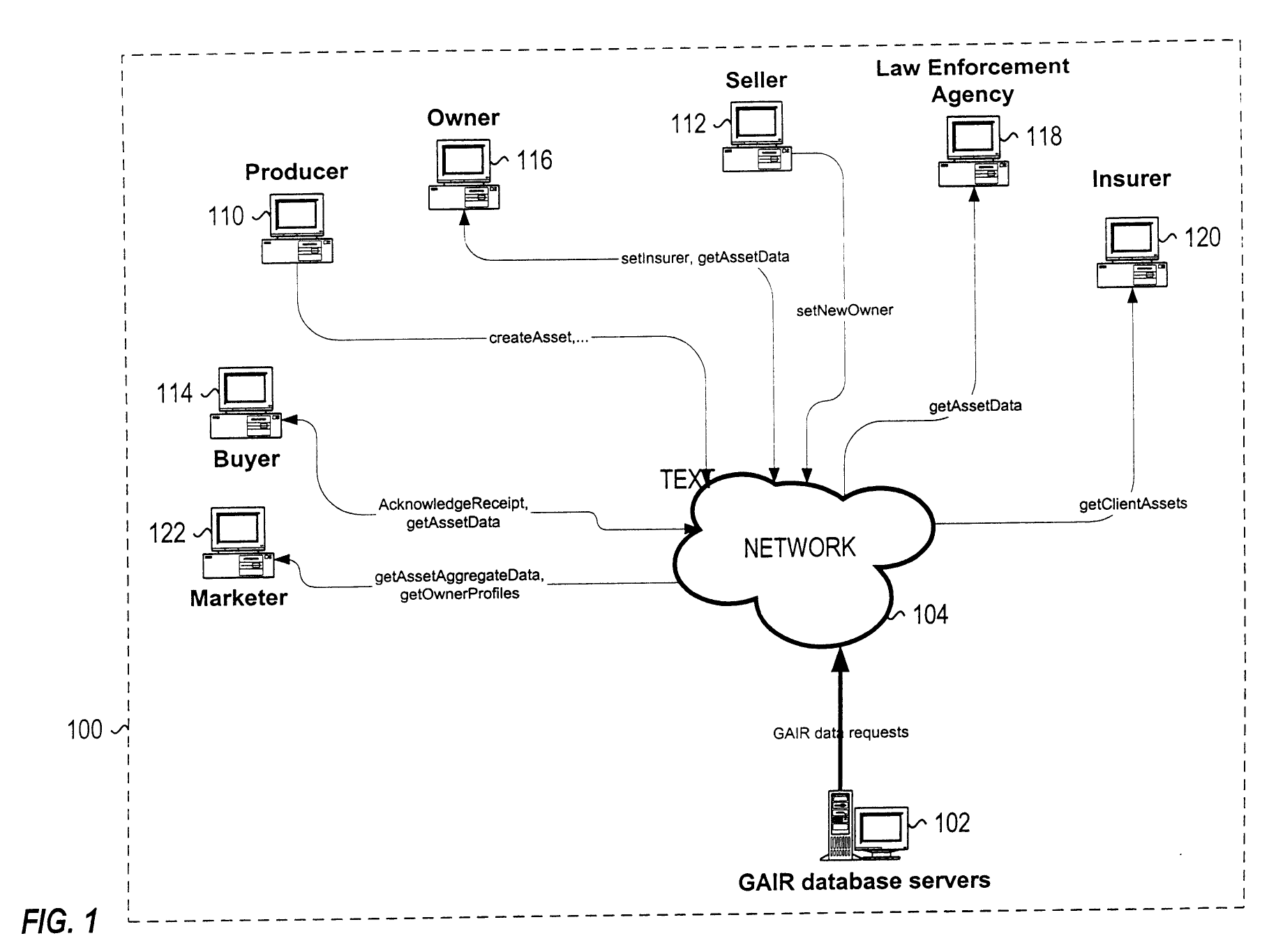

With reference to the drawings, in general, and FIGS. 1 through 10 in particular, the apparatus and method of the present invention are disclosed.

A Global Asset Information Registry (GAIR) is used as a complete tracking and management system for assets. An asset can be anything that is created. Assets may be differentiated from raw materials in that assets have a ‘value added’ component. That is, human beings have processed, formed or manufactured these materials in a way that raw material increases in value. An asset can be associated with or created from other assets. For example, an asset, such as a automobile or computer, is assembled from component parts that are, in and of themselves assets. In creating a multi-component asset, for example, a producer assembles assets and in doing so creates a new single asset. Assets may include but are not limited to: appliances, art, buildings, clothing, digital objects, durable goods, equipment, furnishings, land, vehicles, perishable goods, tools, and weapons. Minimally, assets can be owned, insured, sold, bought and warranted.

FIG. 1 illustrates an exemplary system architecture for a GAIR 100, according to one embodiment of the present invention. The GAIR 100 would be located on one or more servers 102 accessible through a network 104, such as the Internet, or a phone network (wired, wireless, satellite). Various organizations having an interest in the asset, managing some aspect of the asset or simply interested in information pertaining to the asset may be able to access the GAIR 100 through the network 104. The various organizations may include, but are not limited to, some or all of the following: a producer 110, a seller 112, a buyer 114, an owner 118, a law enforcement agency 118, an insurer 120 and a marketer 122.

In order to maintain the data the one or more servers 102 would include some type of database. As one of ordinary skill in the art knows there are numerous databases that could store and manage large volumes of data associated with an asset, including but not limited to Oracle, Sybase, and IBM's DB2.

The various organizations would enter date into the GAIR 100 using one of several methods. As one of ordinary skill in the art would recognize, there are numerous methods for entering the data into the GAIR 100 that include but are not limited to Oracle forms interface, flat files, paper forms that are scanned, hand held scanners (i.e., “palm-top”) and voice recognition. Regardless of what method is used to enter the data, the data is likely transmitted from the person processing the asset (i.e., the producer 110) over the network 104 to the GAIR servers 102. However, it should be noted that the individual or organization processing the asset might be the one maintaining the GAIR servers 102. Moreover, it is possible that the data related to the transaction on the asset would be manually recorded (i.e., on paper) and sent to an individual (or organization) who was maintaining the GAIR 100 and that individual would then update the GAIR servers 102. In this case the network 104 can be considered as the postal service. As one of ordinary skill in the art would recognize, the network 104 could be defined as numerous things now known or developed later that would be well within the scope of the current invention.

Next will follow a discussion of how each of the individual organizations that are illustrated in the exemplary embodiment of FIG. 1 would interact with the GAIR 100. For simplicity, the interaction of the individual organizations will be described in relation to a Ford Explorer Sports Utility Vehicle (SUV). The producer 110 may be the organization that creates the asset. For example, Ford would be the producer 110 of the SUV. The producer 110 may add the asset to the GAIR 100 using one of the methods described above. In a preferred embodiment, when the producer 110 added the asset to the GAIR 100 (i.e., created the asset record) they would include all pertinent data about the asset. For instance, Ford may add data related to the components that make up the SUV (i.e., engine, tires), warranties associated with the SUV, service parameters (i.e., oil change every 3,000 miles), etc. Alternatively, all of the suppliers of components could participate in the GAIR 100 and populate the database with the component information that could then be grouped as a new, assembled asset. This would be the case if suppliers had participated in a business-to-business (B2B) electronic marketplace, or B2B exchange, and had entered their inventory of components into the GAIR 100 at the time they were created. This would allow them to simply change the ownership attribute in the GAIR 100 as the assets that are components, were transferred to the manufacture whose primary role would be to assemble the various components. As one of ordinary skill in the art would recognize there are numerous attributes about an asset that the producer 110 could set or assign in the GAIR 100 that would be well within the scope of the current invention. It can be said that the producer 110 is an original owner of the asset, and as such, controls access to the asset record.

The seller 112 may be Ford or may be an independently owned car dealership. As should be obvious, in the event that the seller 112 was Ford, the seller 112 and the producer 110 would be the same organization. If the seller 112 was different from the producer 110, the producer 110 would likely transfer ownership of the asset to the seller 112. Thus, the producer 110 would change the ownership of the asset in the GAIR 100. As such, the seller 112 would now be the individual (or organization) that controlled access to the asset record of the GAIR 100.

The seller 112 might add data related to the asset in GAIR 100, using any of the above-mentioned methods. For example, the seller 112 might identify when the item was put for sale, when it was sold, who the new owner is, how much the item was sold for, among other things. Moreover, the seller 112 might record any changes made to the asset since the asset was received from the producer 110 (i.e., upgraded tires, rust coating, sun roof, etc.). Moreover, the seller 112 might record any items related to the asset that were transferred (i.e., warranties, service plans, etc.). As one of ordinary skill in the art would recognize there are numerous attributes about an asset that the seller 112 could set or assign in the GAIR 100 that would be well within the scope of the current invention.

The buyer 114 is the one who purchases the asset. When the buyer 114 expresses interest in purchasing the asset, the seller 112 may grant the buyer 114 permission to view all or a portion of the asset record. For example, the buyer 114 may be granted permission to view a parts list of the major components in the SUV, may receive the warranty, etc. If the buyer 114 decides to purchase the asset, they may have to provide the seller 112 with certain information, such as, identification in order to complete the transaction. This information may also be stored in the GAIR 100. After the transaction is complete, the seller 112 may set the ownership of the asset to the buyer 114. In one embodiment, in order for the transaction to be finalized, the buyer 114 would need to acknowledge that they are the new owner. As one of ordinary skill in the art would recognize there are numerous ways in which the buyer 114 could be notified (i.e., fax, email, pager) that they have designated as owner and thus, must acknowledge the transaction and the fact that they are the new owner.

The owner 116 may be the same as the buyer 114 or may be a distinct entity if the buyer 114 simply purchased the asset for the real owner. In any event, the owner 116 may receive data about the asset or update data related to the asset. For example, the owner may inform the GAIR 100 that insurance was purchased on the SUV, or had maintenance performed on it. Alternatively, the insurance company or the maintenance company could be granted permission to access the asset record in the GAIR 100 to update the asset record with the appropriate data (i.e., insurance policy, maintenance ticket).

In a preferred embodiment, any individual or organization who entered data pertaining to an asset would always have access to that data. For example, a parts provider would always have access to their data (i.e., the assets the parts were in). For example, a tire manufacturer would have access to the GAIR 100 to identify all vehicles that their tires were installed on, and thus, the owners of their tires. Thus, in the event of a recall, the GAIR 100 could provide a quick and accurate list of all owners of their tires. In one embodiment, the tire manufacturer could use this list to individually notify owners of a recall. In an alternative embodiment, the GAIR 100 could be used to notify the owners of the recall. In a preferred embodiment, the owners would be notified externally by the tire manufacturer as well as the GAIR 100.

The law enforcement agency 118 can get data related to the asset that may be necessary for a criminal investigation. For example, if the police determined that an SUV with a particular paint style was involved in an accident, the GAIR 100 could give them a list of all the owners of such vehicles. Moreover, if the SUV was stolen the police could get all the particulars about the SUV from the GAIR 100. Furthermore, the law enforcement agency 118 create documents (i.e., accident reports) that are associated with the asset.

The insurer 120 may use the GAIR 100 to acquire information about an asset they are going to insure. Moreover, they may enter insurance data into the GAIR 100, so that information is available to particular parties. For example, if the SUV was in an accident and was in the body shop being fixed, the body shop could obtain data from the GAIR 100 about the deductible, rental car policy, or prices the insurance company would pay for particular items to be replaced.

The marketer 122 could obtain data about who purchases the asset, the most desired features of the asset or any other data that may aid in marketing the asset or strategic business planning.

The concepts of the GAIR 100 will next be describer by making reference to exemplary Unified Model Language (UML) diagrams. As one of ordinary skill in the art would know, UML diagrams provide a means to model business requirements and a design of a particular system. Three different types of UML diagrams are normally used (use case, activity and class). The use case diagram depicts a methodology used in system analysis to identify, clarify, and organize system requirements. The activity diagram is a multi-purpose flow diagram that enables one to model business workflow, the behavior of the system components. The class diagram defines the structure and relationships of objects in the business model. The UML diagrams serve to illustrate and describe example embodiments and implementations of the GAIR 100, but other implementations and embodiments are well within the scope of the current invention. One of ordinary skill in the art will readily recognize the extensibility of such diagrams to include other features, attributes, and methods related to an asset registry (e.g. GAIR).

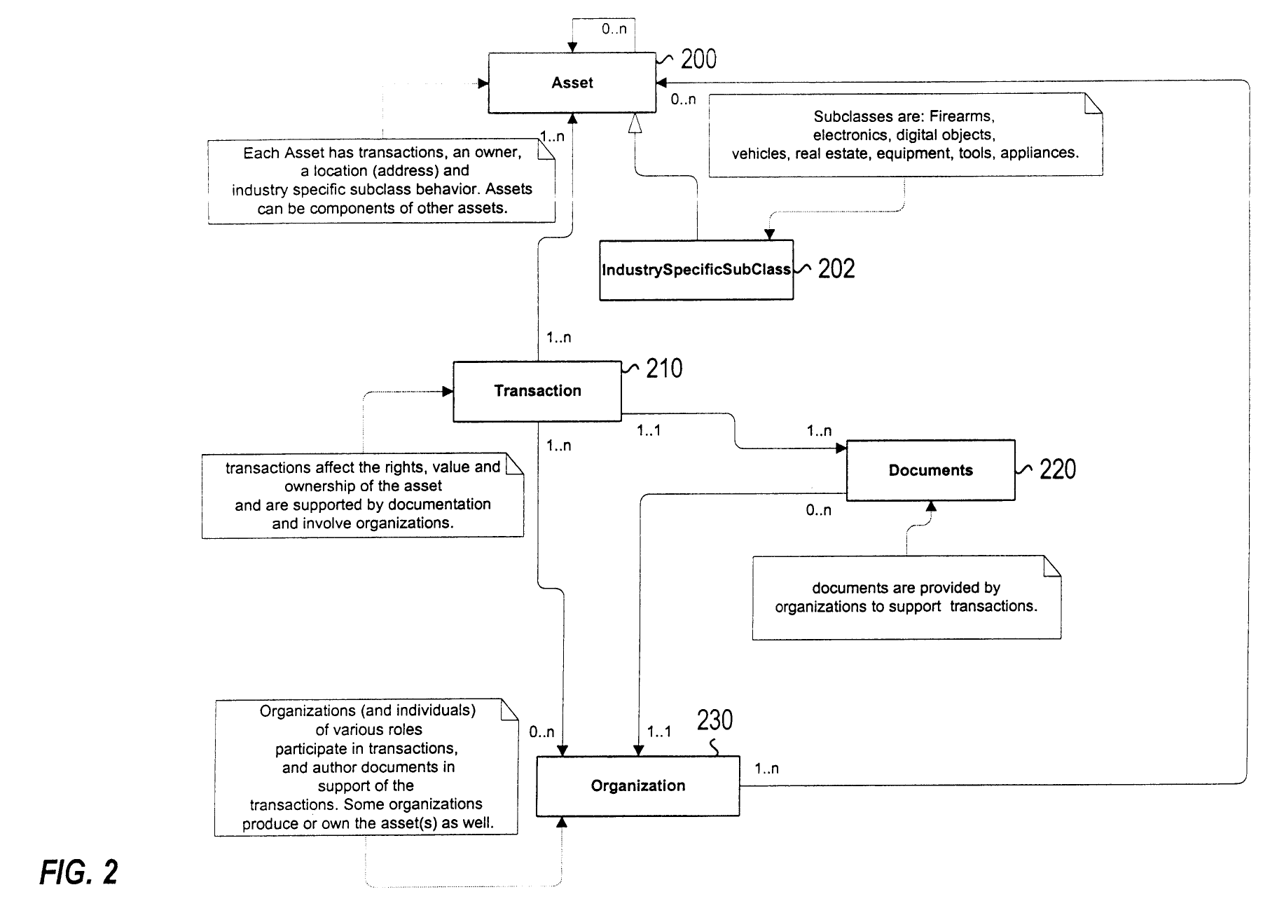

FIG. 2 illustrates an exemplary class diagram showing potential associations with an asset 202. The asset 200 may be designated into a subclass, such as industry specific subclass 210. Examples of industry specific subclasses include but are not limited to; electronics, digital objects, vehicles, firearms and appliances. Assets within a particular subclass may share a number of common behaviors and attributes including, among others, condition, creation date, status, address and warranty. For example, in the subclass electronics one might choose to describe a broad group of business and consumer goods including, but not limited to: TVs, VCRs, projection displays, cameras, DVD/CD Players, computers, computer related equipment, and personal digital assistance (PDA). Typically assets are defined by a set of device dependent common characteristics, which include but are not limited to: make, model, serial number, registration number, date of creation, location (country, state, city, town, village, street, street number, postal codes).

Additionally, descriptors that speak to nature of the asset might be used as an industry specific means of defining asset types, e.g.: consumable, unique or 1-of-a-kind, handmade, mass produced, ancient, customized, music, visual art, and computer software. Moreover, assets 200 might be grouped or related to one another with the relationships between assets including but not limited to: shipments, systems, sub-assemblies, finished goods, buildings, collections, and sets.

As illustrated in FIG. 2, assets 200 may be associated with other assets 200. That is, a car asset may be related to tire assets, engine assets, etc. As illustrated, an asset may be associated with 0 to many other assets. This means that an asset 200 need not be related to any other asset 200. However, multiple assets 200 may be associated with a single asset 200 as would be the case with multiple components (i.e., tires, engine, chassis) being assembled into a final product (i.e., automobile). This type of relationship allows the GAIR 100 to keep track of the “origin” of component parts. Thus, the GAIR 100 is well suited to handle multi-vendor assets 200.

Assets 200 are also associated with transactions 210, and vice versa. Transactions may affect the status of the asset (i.e., creating, assembly, and modification), the ownership of the asset (i.e., buying, selling), or the value of the asset (i.e., appraisal). The selling of a car is a transaction (selling) that is associated with an asset (car). As illustrated, an asset 200 is associated with one or more transactions 210 and a transaction 210 is associated with one or more assets 200. By way of example, one asset (i.e. a car) or multiple assets (i.e., tires, engine, chassis) can be associated with one transaction (i.e., purchase of), or multiple transactions (i.e., purchase of, maintenance on, insurance purchased, loan obtained). The GAIR 100 can track the potentially unlimited number of transactions 210 that occur through the life of the asset 200 and can track all of the assets 200 that a particular transaction 210 effects.

Transactions 210 may be associated with documents 220 and vice versa. Documents 220 may include but are not limited to purchase orders, sale receipts, maintenance records, loan applications, warranties, guarantees, and service agreements. In one embodiment, the documents 220 may include digital objects that might contain a visual record of asset condition, such as a homeowner taking digital photographs/video of their house and it's contents In one embodiment, the registry would provide for documentation that would serve to establish the identity of organizations. For example documents 220 establishing the identity may include, but are not limited to, birth certificates, signature, location of residence, social security numbers, fingerprints and passports.

In another embodiment, the assets 200 may be digital objects, such as copyrighted digitally recorded music. The related documents 220 may be the terms and conditions of use or licenses that are obtained during the transaction 210 of purchasing a copy of the digital object asset 200.

As illustrated a transaction 210 is associated with one or more documents 220, and a document 220 is associated with one transaction 210. By way of example, one transaction (i.e., financing a car) may be associated with one document (i.e., loan application) or multiple documents (i.e., tax returns, pay stubs, bank statements). The GAIR 100 tracks the documents 220 that are associated with each transaction 210.

Transactions 210 may also be associated with organizations 230, and vice versa. As previously described there can be numerous organizations involved in GAIR 100 including those described in FIG. 1. However, as one of ordinary skill in the art would recognize there are numerous organizations 230 that could be involved in a transaction 210 (i.e., a credit card company providing data to a mortgage company) that may not have access to the GAIR 100, and other information may not be entered into the GAIR 100. As illustrated, a transaction 210 can be associated with zero or more organizations 230 and organization 230 must be associated with one or more transactions 210. By way of illustration, one transaction 210 (i.e., updating the age of an asset 200) may have no organizations 230 that are involved. However, one transaction 210 (i.e., financing a car) or multiple transactions 210 (i.e., checking credit reports, getting appraisal, verifying employment) may have a relationship with one organization 230 (i.e., mortgage company) or multiple organizations 230 (i.e., credit bureau, appraiser, employer).

Organizations 230 are also associated with documents 220, and vise versa. As illustrated, an organization 230 is associated with zero or more documents 220 and a document 220 is associated with one organization 230. By way of example, one organization 230 (i.e., police department) may not have any documents 220 that it produces, or that are required to perform a particular transaction 210 (i.e., drive by known criminal establishment), while another organization 230 (i.e., owner of a car) may have one document 220 (i.e., title) or more documents 220 (i.e., title, registration, warranty, insurance) that need to be generated or produced in order to support a transaction 210 (i.e., car repair).

Organizations 230 are also associated with assets and vice versa. As illustrated, an organization 230 may be associated with 0 or more assets 200 and an asset 200 must be associated with one or more organizations 230. By way of example, an asset 200 (i.e., automobile) can have one organization 230 (i.e., owner) or many organizations 230 (i.e., insurer, financer, owner) associated with it. An organization 230 (i.e., insurer) may have no associated assets 200 or may have one or more assets 200 (i.e., automobile, house) associated with it.

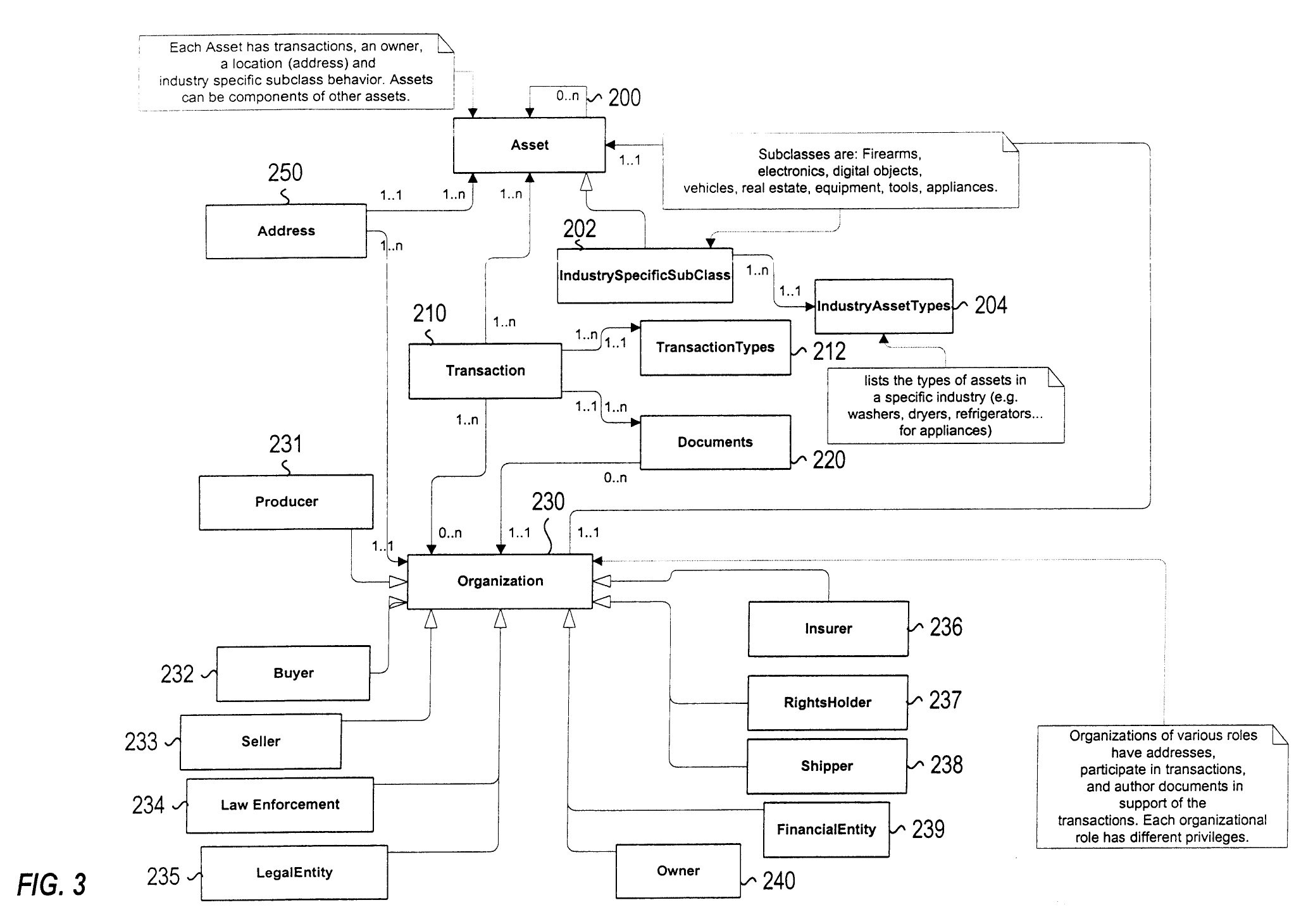

FIG. 3 illustrates another exemplary class diagram. FIG. 3 illustrates the various organizations that may be associated with the GAIR 100, which include but are limited to producer 231, buyer 232, seller 233, law enforcement 234, legal entity 235, insurance 236, rights holder 237, shipper 238, financial entity 239, and owner 240. Each of these organizations 230 may have access to the GAIR 100 to modify the asset record in some manner or to obtain information relative to the asset 200. For example, the producers 231 may have the ability to specify details about the asset 200 being produced, including assigning the asset an identification. The buyers 232 can check the history of the asset 100 and query data on the asset 200. When the potential buyer 232 decides to purchase the asset 200, the potential buyer 232 can make agreements to transfer ownership of the asset 200 for a payment and accept terms and conditions set by the producer 231 and/or seller 233. Upon receipt of the asset 200, the buyer 232 can set the ownership attribute for the asset 200 to itself (thereby acknowledging receipt of the asset).

The law enforcement organizations 234 could, for example, check the status, location, and ownership of an asset 200 in order to track down lost and stolen assets. Also, the law enforcement organizations 234 could query aggregate and summary data to look for patterns of activity regarding types and locations of assets indicating criminal activity. Access to this information can be restricted to prevent unauthorized dissemination of potentially confidential information.

The financial entities 239 can record and/or query for financial transactions, such as, royalty payments, exercising options, debt financing, credit services, and direct payments.

The financial entities 239 such as credit issuing organizations, mortgage companies, credit unions, banks, private investment firms, and the like might provide for transfer of payments or remain engaged in an asset 200 by taking joint title or becoming a right holder in the asset 200.

The insurance provider 230 can use the GAIR 100 to provide detailed records of assets 200 owned by their clients at any time, including location, condition, value and identification data. As one of ordinary skill in the art would recognize, this information would be helpful in managing claims. Moreover, the GAIR 100 can be used to obtain summarized data on all of a client's assets, as well as on the client, which would be useful in setting insurance rates.

Marketing firms may be granted access to aggregate asset data such as producer, insurer, seller, and buyer data. By making marketing data available quickly from one source, smaller businesses are better able to obtain and use the data to respond to consumer preferences. As a result, consumers benefit from more desirable products and services.

FIG. 3 also illustrates that each transaction 210 can be associated with various transaction types. Transaction types 212 are a way to classify transactions for various purposes, which would be obvious to those of ordinary skill in the art. As illustrated, each transaction 210 must have one transaction type 212 and a transaction type 212 must be associated with one or more transactions 210.

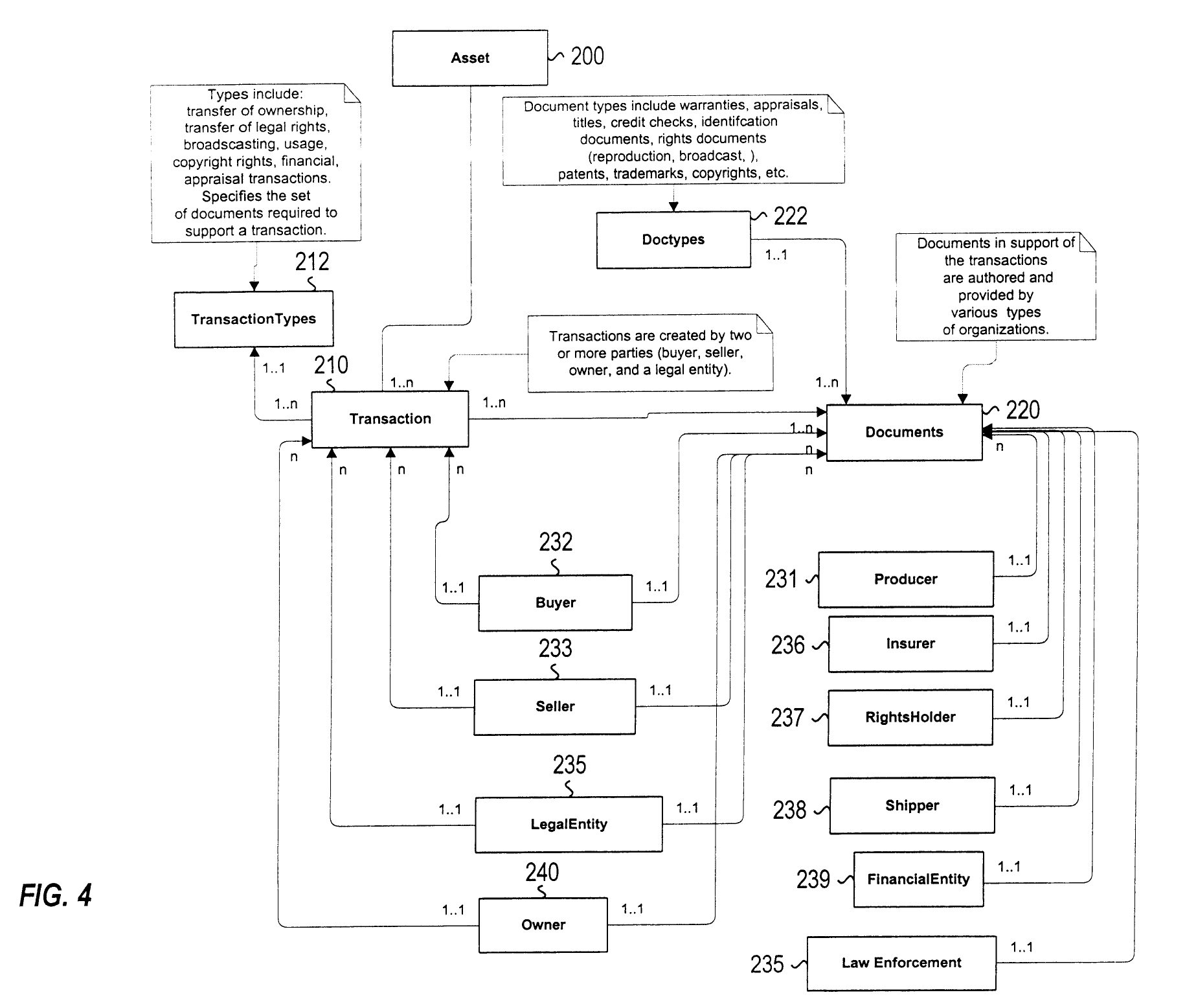

FIG. 4 illustrates another exemplary use case. FIG. 4 illustrates how each of the organizations may be associated with the transactions 210 and the documents 220. For example, the buyer 232, the seller 233, the legal entity 235 and the owner 240 may be associated with both the transactions 210 and the documents 220. As illustrated, each of these organizations is associated with multiple transactions 210 and multiple documents 220. For example, a buyer 232 (i.e., John Smith) may have performed multiple transactions 210 (i.e., buying several items) and also produced multiple documents (i.e., purchase records).

In contrast, the producer 231, the insurer 236, the rights holder 237, the shipper 238, the financial entity 239 and the law enforcement agency 235 may only be associated with the documents 220. That is, these organizations would only produce documents 220 in support of the transactions 210 and will not take place in the actual transaction. As illustrated, each organization is associated with multiple documents 220 and each document 220 is associated with one organization.

FIG. 4 illustrates that each document 220 can be associated with various transaction types. Transaction types 212 are a way to classify transactions for various purposes, which would be obvious to those of ordinary skill in the art. As illustrated, each document 220 must have one document type 222 and a document type 222 must be associated with one or more documents 220.

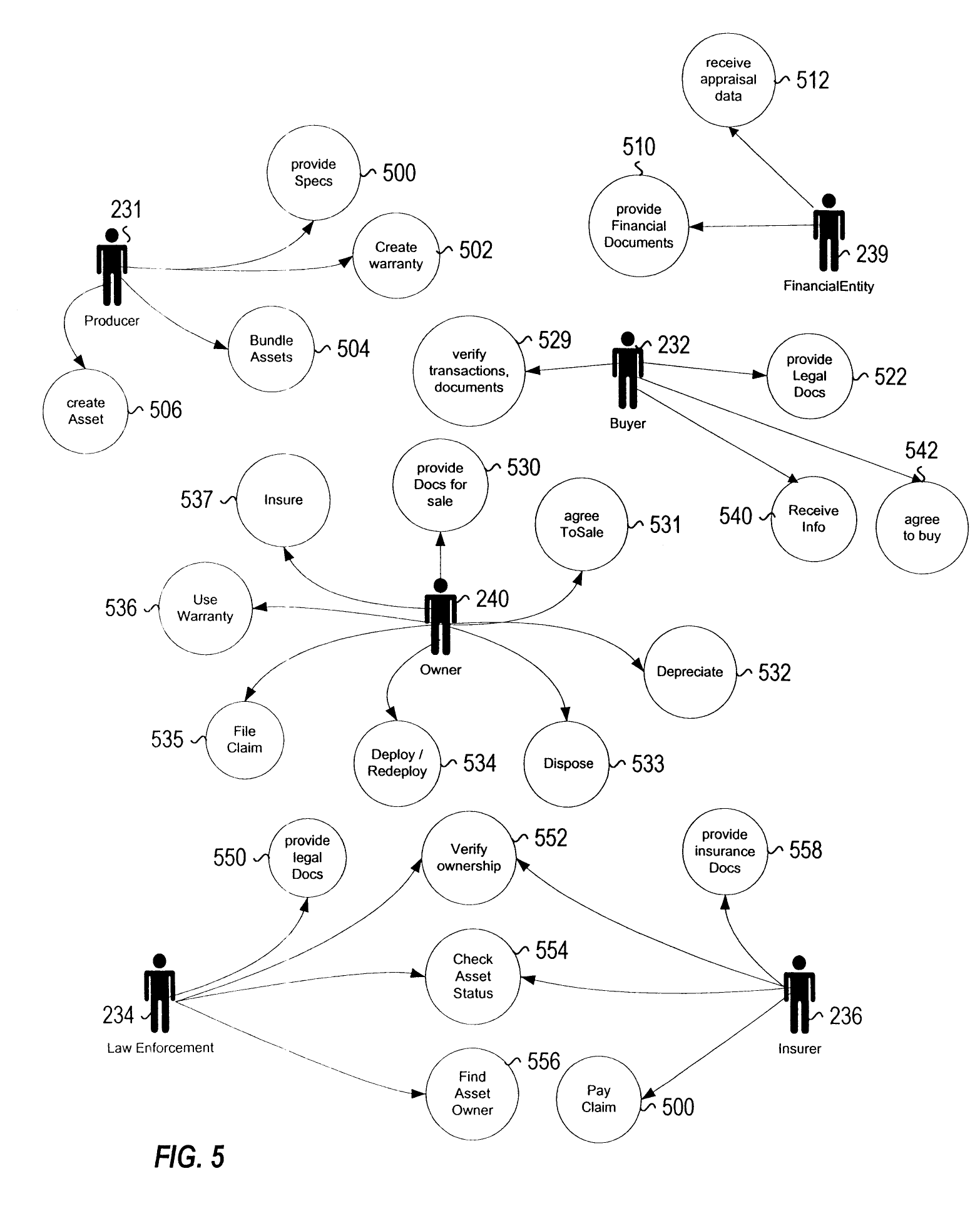

FIG. 5 illustrates an exemplary use case diagram for the GAIR 100. As illustrated the producer 231 of an asset may create the asset (506) and enter information related to the asset into the GAIR 100. The information about the asset can include very little or very complex data depending on the asset. For example, a simple asset such as a widget may simply have a part number, a lot number reflecting the time it was produced, and the name and address of the producer 231. A multi-vendor asset such as an automobile may have data relating to all of the individual components of the automobile (i.e., engine, tires) and data pertaining to how, when and where each of the components were assembled together and processed in any fashion (i.e., painting the automobile). The asset should have some type of unique identifier assigned thereto. In a preferred embodiment, the unique identifier is an identifier that is already assigned to the asset so that current business methods are not be affected. For example, an automobile could use the vehicle identification number (VIN) as the unique identifier since all automobiles already have such a unique designation.

The producer 231 may the bundle assets together (504) for any number of reasons, including organization or classification of the assets. For example, assets may be bundled into a specific product type, product line, or color type. The producer 231 may provide specifications for the asset (500) and include electronic copies of the specifications in the GAIR 100. The electronic copy of the specification may be a scanned copy of paper specifications normally associated with assets or may be an authenticated digital original. In the case of the authenticated digital original, this specification may be the only specification transferred with the asset (i.e., paper copy not transferred). Asset specifications may include but are not limited to user manuals, troubleshooting guides, part lists, and contact information.

Depending on the type the asset, the producer 231 may provide a warranty with the asset (502). At a minimum the GAIR 100 will have reference made to the warranty. However, in a preferred embodiment the GAIR 100 should contain an electronic copy of the warranty therein. Having the warranty contained therein would ensure that the warranty was available to the owner at all times and would not rely on the owners filing techniques. Moreover, having the warranty available in the GAIR 100 would allow a repair person to access the warranty prior to performing repairs. That is, the owner may provide the repair person with access to the warranty contained in the GAIR 100 so that the repair person could determine in advance what was covered by the warranty.

The buyer 232 may receive data about an asset (540) when the buyer 232 is contemplating purchasing the asset. For example, Ford may provide a potential buyer 232 of a particular car, with read access to information in the GAIR 100 about the particular car. The potential buyer 232 may be provided with access to all the data within the GAIR 100 or to some subset of the data. Depending on the complexity of the buyer 232, Ford may provide more or less data. For example, a car expert may want access to all data including every part within the car, who assembled the car, etc. The buyer 232 may then agree to purchase the asset (542). In order for the purchase transaction to be consummated, the buyer may need to provide legal documentation (522) establishing their identify, financing, or permission to buy the asset. Permission to buy the asset may be parental consent for a minor or may be registration forms that are required prior to an asset being sold (for example, gun registration). Once the purchase is complete, the owner 240 of the asset would record the sale of the asset to the buyer 232. In turn, the buyer 232 may have to acknowledge that they are now the owner of the asset and that they received all the appropriate documents, etc. (529). It should be obvious that any documents associated with the asset may be transferred manually (such as paper copies) or may be transferred electronically as the buyer 232 now has access to all the documents stored within the GAIR 100.

The financial entity 239 may provide financial documents for the asset (510), such as an approved mortgage. As should be obvious, the seller of the asset would want to ensure that the buyer had sufficient funds to purchase the asset prior to completing the sale. Moreover, the financial entity 239 may be granted access to the GAIR 100 to obtain information related to the value of the asset (512) which may be in the form of an appraisal. Alternatively, the information with the GAIR 100 about the asset may be used by the financial entity 239 to appraise the asset. For example, if the financial entity 239 wanted to appraise the value of a home prior to approving a mortgage, the financial entity 239 may look at the various products that were used to build the home, the warranties associated with the home, and the size of the home in order to help establish the appraisal value of the home. Providing all this information gives an appraiser more objective data for which to base an appraisal value. Moreover, the financial entity 239 would have access to data that they would otherwise have to potentially go on site to obtain (i.e., dimensions, etc). Thus, providing a financial entity 239 with access to this data can reduce the amount of time and increase the efficiency of certain financial transactions 239.

The owner 240 of the asset may provide documents for sale (530), agree to sell the asset (531), depreciate the asset (532) (i.e., real estate), dispose of the asset (533) (i.e., a car), deploy the asset or re-deploy the asset (534) (i.e., a radar system), file a claim with an insurance company (535), use the warranty to have the asset repaired or replaced (536), or insure the asset (537). As one of ordinary skill in the art would recognize there are numerous applications for each of these use cases and there are numerous other use cases for the owner 240, that would be well within the scope of the current invention.

The law enforcement agency 234 may provide legal documents (i.e., police reports) associated with the asset (550), verify the ownership of the asset (552), check the status of the asset (i.e., lost, stolen) (554) or find the owner of an asset (556) in the event that and asset was found. The insurer 240 can also check the status (554) and verify the ownership (552) of the asset as well as providing insurance documents (558) and paying claims (560).

The GAIR 100 would be designed in such as fashion as to store all data described above and potentially endless other amounts of data for the asset. Numerous organizations could have access to the information. Some organizations would have access to all of the data while others would have limited access. Some would have read access only while others would have write access as well. The exact set-up of the GAIR 100 would depend on the asset. It is assumed that the owner of the asset would be the one providing access (or permission to access) to other organizations. However, it will be assumed that any organization adding data about a particular asset will at a minimum have access to the data that they added. For example, a producer would always have access to the specification (i.e., parts lists, assembly diagrams) that they produced for the asset. An insurer would always have access to the policy and any claims associated with the asset. The law enforcement would have access to any reports they produced with reference to the asset.

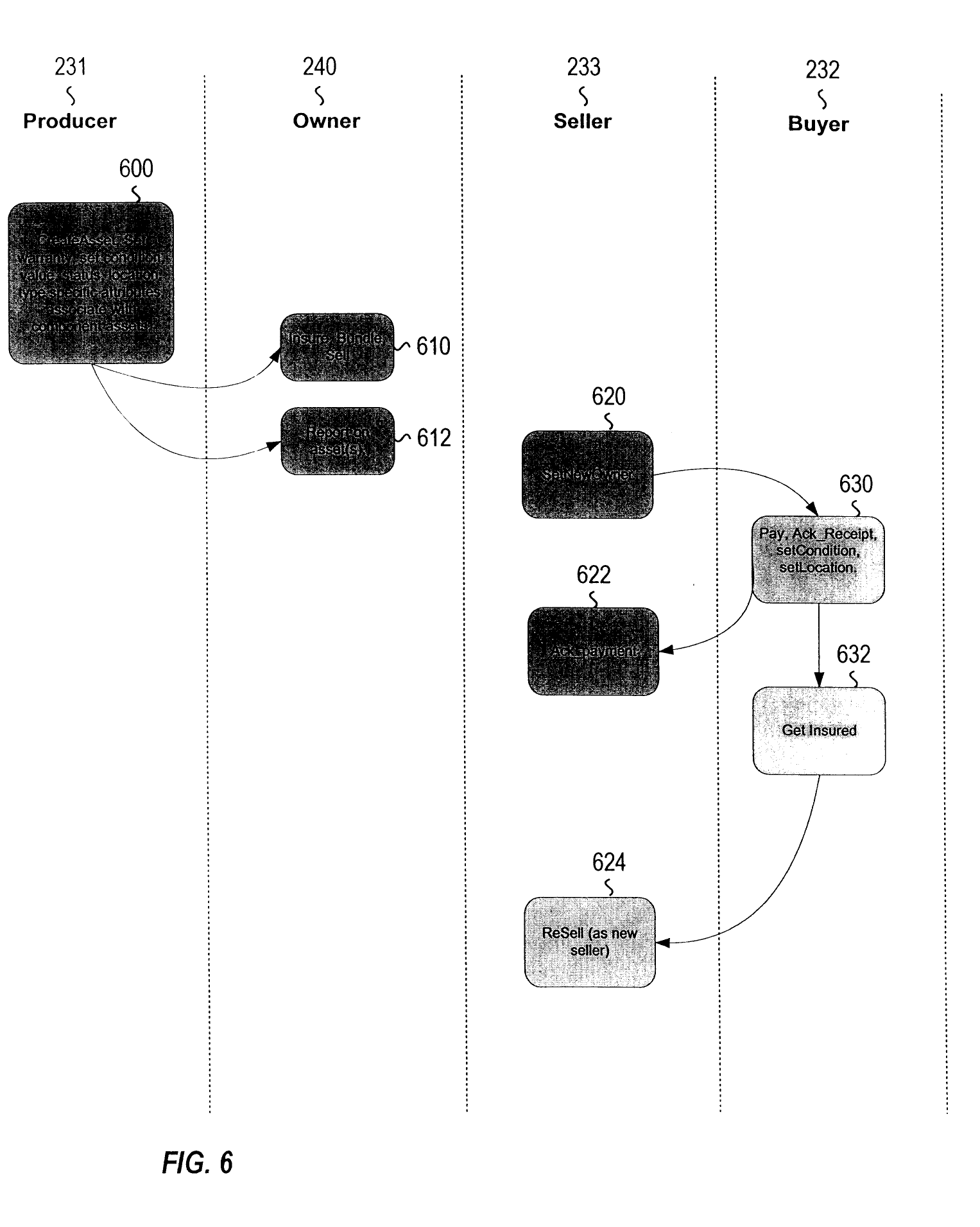

FIG. 6 illustrates an exemplary activity diagram for the transfer of ownership of an asset. As illustrated, after producing the asset the producer 231 may create a record of the asset with all the pertinent data about the asset (600), including but not limited to setting the warranty, the condition of the asset, the value of the asset, the status, the location, any type specific attributes, and any association with components (i.e., parts lists). Once the producer 231 of the asset either becomes the owner 240 or transfers ownership of the asset to another, the owner 240 may insure, bundle or sell the asset (610). If the owner 240 decides to sell the asset they become a seller 233 and may assign ownership of the asset to the new owner (620). The buyer 232 may pay for the asset, acknowledge receipt of the asset, and set the location and condition of the asset (630). In response to payment of the asset the seller may acknowledge receipt of the payment (622). The buyer 232 may then insure the asset (632). If the buyer 232 decides to resell the asset he can do this as a new seller of the asset (624). As one of ordinary skill in the art should recognize, this activity diagram is merely one example of how activities could be performed by various organizations, and how ownership of the asset changes, during the life cycle of an asset. There are numerous other activity scenarios that would well within the scope of the current invention.

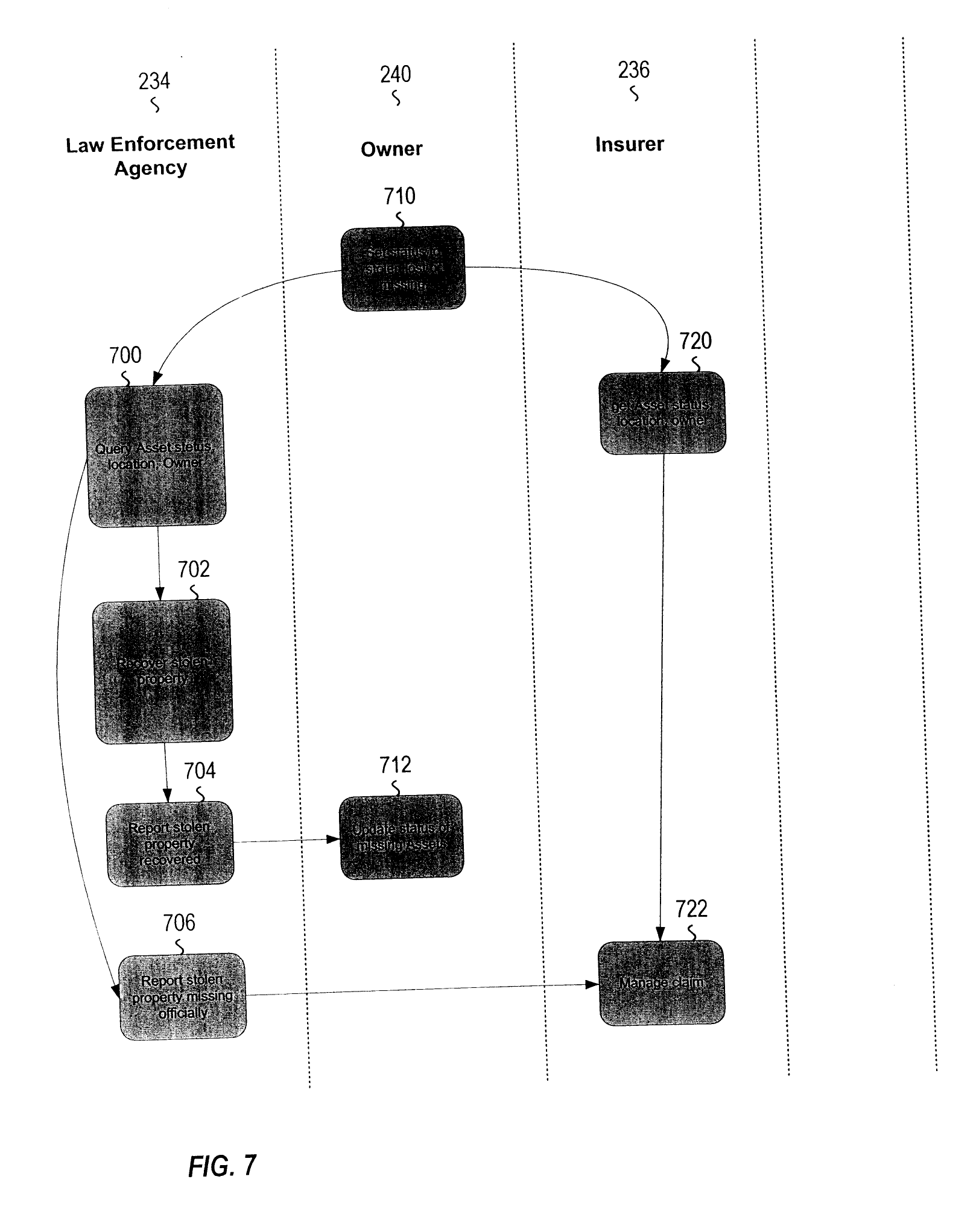

Third parties may be granted access (permission) to the asset record (or at least a relevant portion thereof) in the GAIR 100. The third parties may be granted permission to read part of or all of the asset records and/or to write to the asset record. As one of ordinary skill in the art would recognize, the write permission could be limited (i.e., an insurer could only add data related to insurance, such as an insurance policy and could not change the contents of the asset). FIG. 7 illustrates an exemplary embodiment of two different third parties being given permission to access the asset record. In this example, the owner 240 of the asset has lost possession of the asset. As such, the owner 240 of the asset sets the status of the asset to stolen, lost or missing (710). The law enforcement agency 234 is then notified. The law enforcement agency 234 may query the asset status, the location of the asset, or the owner of the asset (700). Based on the queried data, the law enforcement agency 234 may recover the stolen property (702). If the law enforcement agency 234 is able to recover the asset, they would update the GAIR 100 to report the fact that the stolen property has been recovered (704). As such, the owner 240 of the asset would update the status of the asset (712). Alternatively, the law enforcement agency 234 may not be able to find the asset in which case they report that the asset is officially missing (i.e., stolen) (706).

The owner 240 may also report the lost, missing or stolen asset to the insurer 236 (i.e., insurance company) and the insurer may retrieve information related to the asset status, location and owner (720) in order to manage an insurance claim on the asset (722). The fact that the law enforcement agency 234 officially considers the asset missing will also be used in managing the claims of the insurer. The above is merely an example of one way third parties can be granted access to the GAIR 100 for a particular asset. In the illustrated example, both the law enforcement agency 234 and the insurer 236 were granted read permission to the asset record and then were given write permission to process a police report (704, 706) or an insurance claim (722). One of ordinary skill in the art would recognize that there are numerous examples of third parties being granted permissions to access asset records in the GAIR 100 that would be well with the current scope of the invention.

In an example embodiment, the creation and use of a common, inter-operable source allows for efficiencies to be gained in every component part of the practices currently used. In this example, a producer of materials would populate the database with an initial record of the object at the time of its creation. The producer would have access to add records to the database according to a universal structure that would define all categories of assets. For example, the producer may incorporate into the asset record information that identified itself or themselves as the creator of the asset as well as unique attributes that would identify the object characteristics (among other attributes). A typical approach is to use; Make/Model and Serial Number are attributes that could remain a part of the present design. In other words, producers could continue to use their present methods of stamping or identifying objects (imprinted serial numbers, authorization codes, labels, bar codes, badges, etc.) and the system would allow for digital capture of that information.

The producers would identify themselves as the current owners of the asset and would build into the record ownership attributes against the asset data. In strict terms, they would not only be producers but owners of that data as well. In addition, the producer may assign a valuation. Amounts later paid for the asset may vary from the standard valuation and the present invention allows for the terms of payment for the asset to be attached to the asset.

Asset owners can keep track of what they purchased from whom, where it got deployed and what the status is. Users of GAIR would know that the data was secure. Users would, in a preferred embodiment, not be responsible for the management of an inventory database themselves, but could if the circumstances warranted.

In an embodiment that reflects some traditional economic distribution models, producers would transfer ownership, or at least control, of the asset to a distributor. The distributor may obtain the rights of a ‘reseller’ while only making partial payment for the asset. These rights might be transferred on ‘credit’ or ‘account’.

Lot or shipment information may also be associated with a group of assets and title to those taken in that form. The shipment number allows for goods in transit to be temporarily grouped and the shipment number then serves as a common reference for those assets. Rights to the asset may move quickly from producer, to shipping agent and through to a distributor, in a short time frame. Across this phase, condition is often checked and checked again and payments are adjusted accordingly if the assets are damaged in transit.

In the current economic channels, a single asset might move through several layers of manufacture, transit and of distribution and with that, the ownership and other attributes of the asset might transfer repeatedly and in rapid succession. Moving the data associated with the asset into and out of proprietary or stand-alone computer systems is both labor intensive and as a result not only costly but also vulnerable to human error in the manipulation of the data.

A new economic practice is emerging which has manufacturers going directly to the customer and becoming a retailer as well. Some manufacturers are continuing to provide for products that will move through the traditional channels while at the same time conducting business directly with the end consumer. Examples of this are Dell and Hewlett Packard.

Current practice in industry is to provide for ‘ownership registration’ by method of mail-able forms or electronic registration with the producer of objects. The burden is placed on the purchaser of an object to complete a form recording the make, model and serial number and other data relating to the purchase of the good, such as the retail location, method of payment and price paid.

Individuals and other entities would benefit by having a single database that would contain information on all things (or subclasses of things) that were owned. In case of loss, theft, damage, destruction, etc. of that object, the owner would be able to provide proof of ownership to law enforcement or to insurance agencies. It would also mean that individuals might maintain their privacy by providing only a single identifier (issued and created with a GAIR) as a pointer to their records. This would allow a Seller to only need to collect a single data point rather than reentering the data and also allow a buyer/owner to do the same.

Insurance agencies could ensure accurate and timely claims processing and adjustment through use of an asset registry. The described system would specifically provide for recording of current condition (important in valuation of the object) either through written or visual record, e.g., digital images (moving or not) that capture information regarding the condition or the object. Insurers can better manage their client's accounts with read access to their clients' data. Insurer would be able to more effectively manage claims.

Service and repair organizations could make use of the registry to determine parts, warranty and availability of parts according to data obtainable regarding the object. These organizations can also quickly ascertain the eligibility for service or repair covered by warranty, e.g., home appliances, electronics, or motor vehicles.

Retailers, auctioneers, resellers or wholesalers may deal with the original transaction from producer to purchaser as well as subsequent transactions of ‘used’ or re-manufactured objects. Vendors can better manage their clients support services knowing that the asset owners have a vested interest in keeping the data detailed and up to date, thereby providing better detail on usage and client profiles. Vendors will be better able to respond to clients with targeted marketing and specialized offers based on their client profiles of one or more classes of assets or of all their assets, not just those purchased form the vendor.

While certain records are being kept by these entities (e.g., homeowner's maintain inventories of the contents of their homes, music producers track distribution, etc.) there is significant value in having these records maintained within a single or central source or both. Here the term, interoperability, has been used to signify not only universal access (albeit perhaps limited access depending on the party and circumstance) to the system, but also to signify capture of all information of importance related to ownership and other attributes of the asset.

Particular embodiments of the systems and methods as described here would also provide for the automation of the record keeping itself. For instance, producers might participate in the creation of the object record, populating the initial record relating to an object, or describing it and a DNA like map of it's own attributes and individual component parts.

Transactions, regarding the exchange of ownership rights, for example, would be incorporated into the system. Exchanges of objects would then have an audit-able trail that would relate to ownership over time. This would be valuable to the legal system if ownership were disputed as in divorce, dissolution of business relationships, etc.

Marketers, who do research with aggregate data of client profiles and their assets will now have a repository of asset & owner data. Marketers will have to rely less on expensive, lengthy and inaccurate surveys—which means that vendors in turn will be able to be more responsive to their customers.

The invention anticipates that given the critical need to have some records of ownership be public, and some private that various embodiments of GAIR would incorporate robust and state of the art security. The security might include network transports, SSL's, as well as data encryption as well as identification and authorization. Database engines such as Oracle 8I would provide for a means of user login routines as well as a designated set of view restrictions based on the user's identity.

In one embodiment, state of the art user authentication, user authorization, message non-repudiation and data encryption techniques are utilized. These capabilities, well known to those skilled in the art, will ensure secure electronic communications and system access using the highest-level commercial standards. These standards will ensure that (1) users are properly authenticated; (2) ensure that users only have access to data and functions based on the roles granted them; (3) ensure that messages sent to. and from the system components are from whom they are supposed to be from (i.e., via digital signatures); and (4) ensures that data is encrypted in transmission and possibly in storage.

For example, user authentication may be done with smart cards with automatically changing passwords, public and private key methods and other methods. User authentication might be based on common system roles, as used in many database systems today to grant access to specific data and functions based on the roles assigned a user. Non-repudiation, which guarantees that a message is from whom it says it is from, can be done with digital signatures. Finally, encryption in data transmission can be done with SSL, SHTTP and emerging standards. Together, the use of highest available security methods will encourage participation in certain GAIR processes and applications.

The invention anticipates the scale of the registry/repository or registries/repositories and the acceleration of its/their growth through implementation. If one were to consider only the number of digital objects in existence now and anticipate the number of additional objects in the future, the scalability of such a system is readily apparent. It may therefore be necessary, in certain applications, to implement in a scaleable system. The GAIR 100 would be able to grow to store data concerning very large numbers of assets and users. For example, the system might be deployed on multiple very large disk arrays to cope with the data storage needs.

According to one embodiment of the current invention, it may be important to provide/maintain access to the GAIR 100 at all times. Hence, reliability of the system would be of significant importance. In order to provide a highly reliable GAIR 100, the system would have to incorporate load balancing, full blown redundancy, and fault tolerance. Given the vast scale and criticality of availability, particular embodiments of the system implementation may require deployment in a most robust manner. Those skilled in the art will readily be able to deploy a system that will meet the following requirements:

The GAIR 100 could be designed to meet extremely high levels of user connections. For example, the system might be deployed in a distributed, hot fail over manner such that multiple paths to connect to the database are available from around the nation and the world. That is, there may be multiple data centers along key Internet trunk lines that provide access to the system. Data replication to these sites may provide the fastest access to the system and assure accurate data representation.

The GAIR 100 system would be designed to be highly fault tolerant such that there are no single points of failure. In such a circumstance, no single component of the system hardware or software could be deployed in a manner that if it fails the entire system will fail. This fault tolerance will guarantee the required up time. Redundant hot fail-over server configurations and multi-tier load balancing hardware and software would be required. These techniques are well known and in use today by those skilled in the art.

The GAIR has been described above in terms of general concepts. The following sections will describe in detail specific implementations of the GAIR in specific industries, as well as particular business methods that could be employed.

One specific industry that could use the GAIR is the multi-vendor asset industry. A multi-vendor asset is an asset that has components from more then one vendor and that may be maintained by other vendors. The multi-vendor implementation will be described with specific reference made to vehicles.

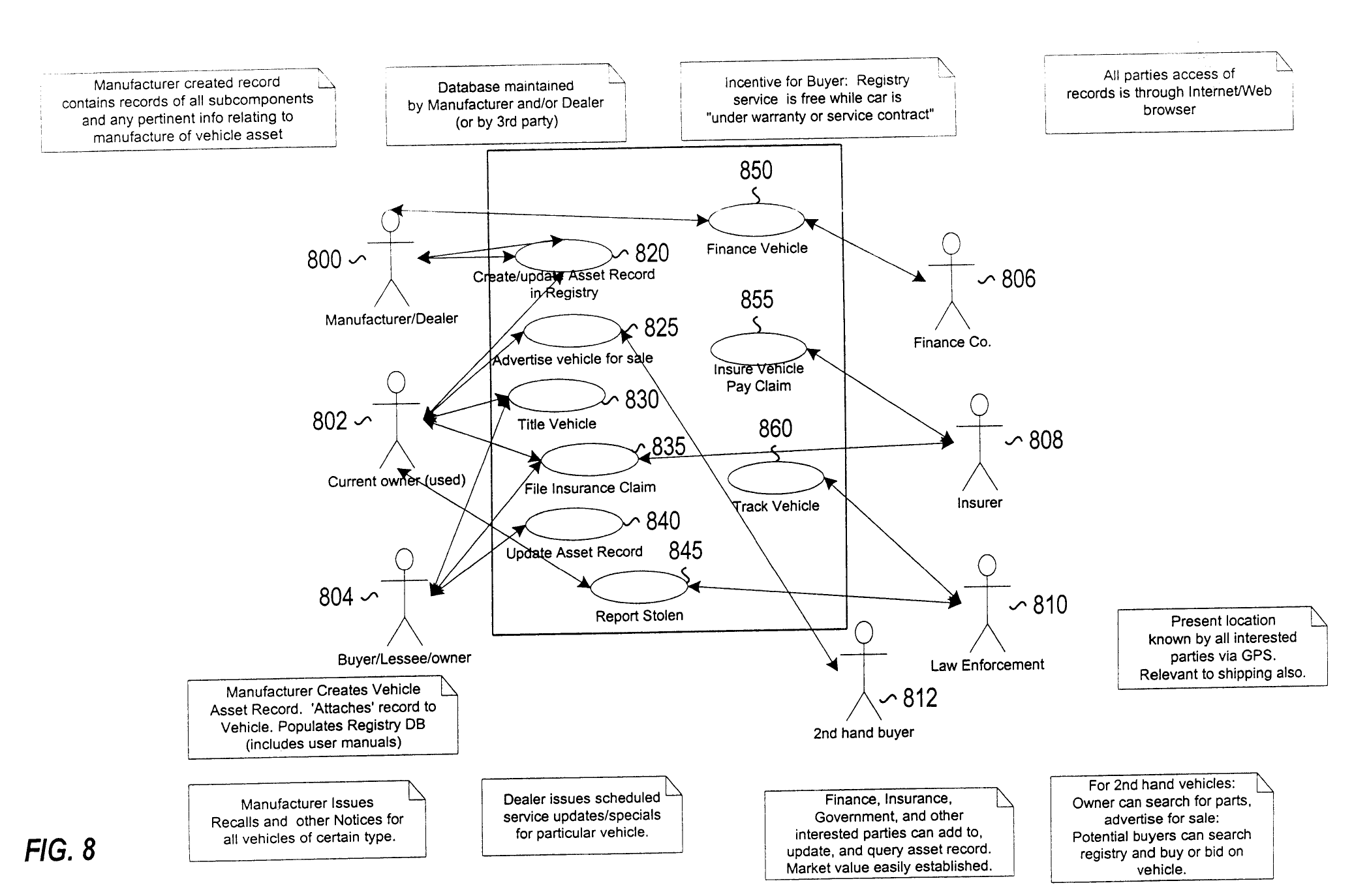

FIG. 8 illustrates an exemplary use case diagram for a vehicle GAIR. As illustrated a manufacturer/dealer 800 may create and/or update an asset record in GAIR (820) and may finance the vehicle (850). A current owner 802 may create the record (820), advertise the vehicle for sale (825), obtain title for the vehicle (830), file an insurance claim (835), and report the vehicle stolen (845). A buyer, lessee or owner 804 may obtain title for the vehicle (830), file an insurance claim (835), and update the asset record (845). A finance company 806 may finance the vehicle (806). An insurer 808 may insure the vehicle and pay claims (808) and may be informed that an insurance claim was filed (835). A law enforcement agency 810 may track the vehicle (860) and be informed that the vehicle was reported stolen (845). A second hand buyer 812 may receive the advertisement for the vehicle (825).

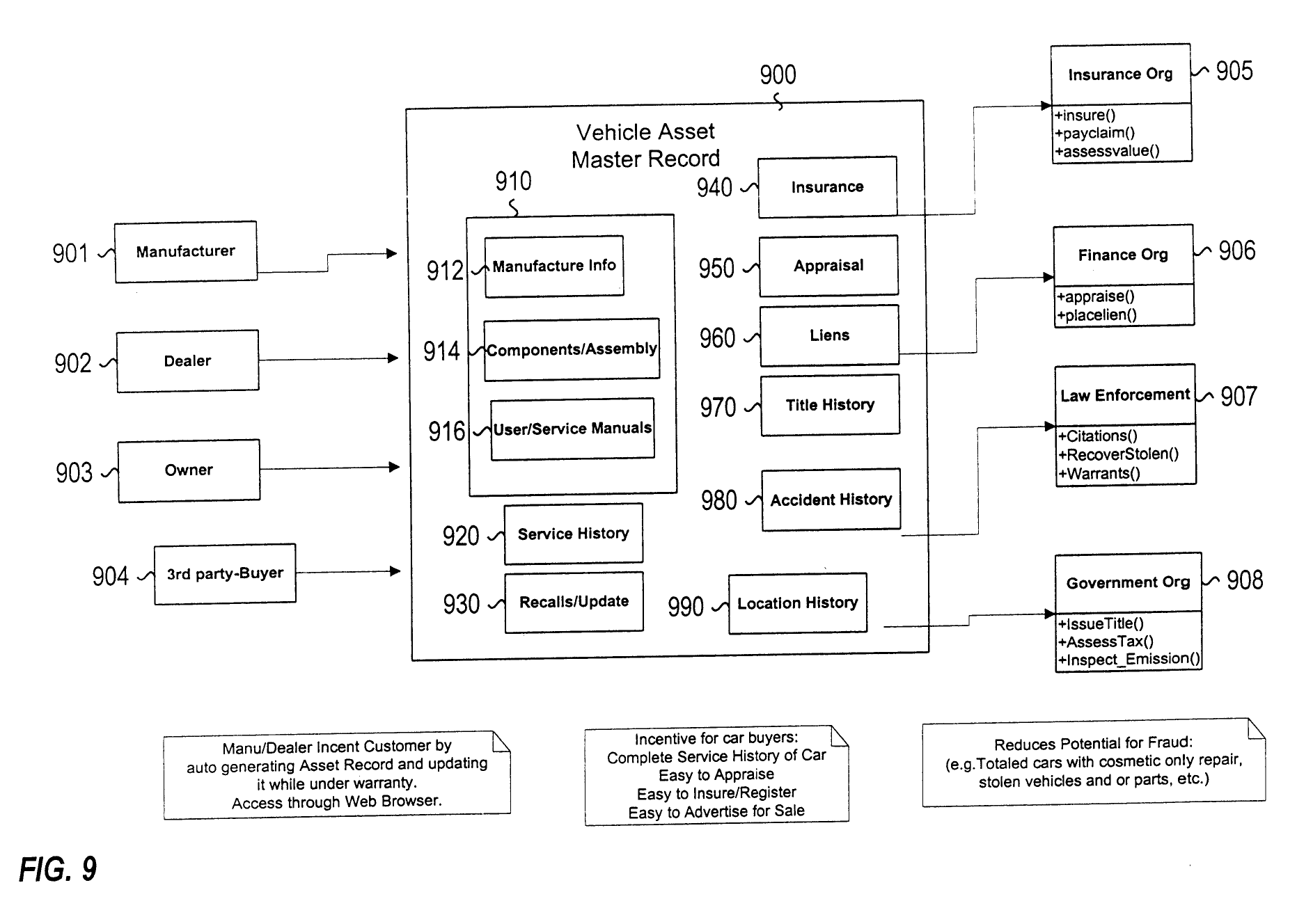

FIG. 9 illustrates an exemplary master record 900. The various organizations that may write data to and read data from the master record include a manufacturer 901, a dealer 902, an owner 903, a buyer 904, an insurance company 905, a finance organization 906, law enforcement 907, and government organizations 908. The manufacturer may populate the initial production data 910 that includes manufacturer information 912, information about each of the components and assemblies that make up the vehicle 914, and any user manuals, service manuals, warranties and or other paper work associated with the purchase of a vehicle 916. According to one embodiment, the manufacturer 901, the dealer and the owner 903 would have access to the information stored in the initial production data 910.

The owner 902 and potentially any buyers 904 would have access to information regarding the service history 920 and any recalls and/or updates 930. The insurance organizations 905 would write data related to the insurance policy 940. The financial organizations could read and/or write data related to appraisals 950, liens 960 and title history 970. Law Enforcement 980 could read/write data related to the accident history of the vehicle 980. The government agencies could read/write information related to the location history of the vehicle that may be important for taxes, emissions, etc.

The vehicle GAIR would contain as few or as may asset specific or asset related records as desired and would preferably contain all value related records as well as other records of “intangibles” regarding the vehicle asset. The vehicle asset record could be created at any time by any party with sufficient interest, but preferably would be created by the manufacturer at or before the completion of assembly of the vehicle. All of the records of components, including multi-vendor components which make-up the vehicle, along with assembly details, specifications, manuals and any other records relating to the manufacturer of the vehicle could be included in the master asset record created at or during production. The master vehicle asset record would be associated with a unique identifier (e.g. VIN). Authorized users of the vehicle GAIR could access a particular vehicle asset record with the unique identifier.

Various access and ownership privileges to the asset record would be transferred from the manufacturer (or other registry service provider) to interested parties. However, the registry itself would still be maintained by the registry service provider (e.g. manufacture, dealer, etc.). Examples of such interested parties are dealers/distributors, potential and actual purchasers (owners), shippers, finance and insurance organization, law enforcement, tax and other regulatory bodies. Ideally, the owner of the vehicle would have ultimate rights to modify and grant access to the asset record to other parties. Relevant records regarding the vehicle would be retrieved, added, or updated by various parties depending on their interest and permissions. Ideally, all status changes, including service, accidents, repairs, manufacture recalls and updates, ownership, insurance, finance, and legal status changes would be added to the record an the record updated according. The vehicle asset record would then track and chronicle all changes to the vehicle, value related and otherwise. As such, the asset record would reflect the “current state” of the vehicle. Additionally, the vehicle if equipped with a GPS or similar device, would have its position tracked, perhaps in real-time so that access to the vehicle record would provide location information as well.

The vehicle asset registry would contain the records of all vehicles “registered”. However, the records of an individual vehicle could only be accessible by authorized parties. Any interested party could provide and maintain the registry as a free or fee for service system. In one embodiment, automobile manufacturers themselves and/or the distributing dealer would maintain the registry. Examples of other parties who may provide/maintain such a registry service include, but are not limited to, insurance, finance, law enforcement, and 2^{nd} hand (user) car vendors.

The manufacture of a vehicle would create a vehicle asset record in addition to manufacturing the vehicle. The vehicle asset record includes all pertinent information including but not limited records on sub-components, assembly and other manufacturing details, warranties, specifications, parts, owners manuals, maintenance and service schedules, and much if not all of the supply chain management and logistics of assembly. These records would be used subsequently for purposes such as quality assurance, tracking, repair and replacement part identification and procurement, appraisal, insurance, law enforcement purposes, purchasing decisions, marketing, etc. In a preferred embodiment, all pertinent records of all aspects of the vehicle manufacturer would be included in the vehicle asset record. These records encompass and could be tied-in to the manufacturer's own supply chain management system, which would track parts and other assembly details.

In one embodiment, a specific digital identifier and/or record is permanently attached to the vehicle. This identifier could hold as much information related to the vehicle asset as desired including all the records themselves. Thus whenever a vehicle is serviced or otherwise evaluated, this repository (digital or analog) would be readily accessible on/in the vehicle itself, providing interested parties direct access to the vehicle's makeup (i.e. specifications, service manuals, etc.). This vehicle record could be a permanent read-only storage unit, or fully editable with additional storage such that any updates (e.g. repairs, service, etc.) or other status changes (e.g. ownership, recalls, etc.) could be stored on the record “attached” to the vehicle.

In one embodiment, the vehicle asset record is transferred from the manufacturer or dealer to the buyer or other party. The transfer of the asset record can be done in numerous ways. In one embodiment, the asset record is transferred via a digital medium, such as, floppy disk, zip disk, tape drive, CD, DVD, smart card, etc. In a preferred embodiment, the asset record is transferred over a computer network, such as the Internet. Using the Internet allows the manufacturer or dealer to make the vehicle asset record available to customers or other interested parties even if the are remotely located.

In the simplest case where there is not a centralized registry/repository, the manufacturer would send “duplicate” records to all parties. In a more efficient manner however, the manufacturer and/or dealer would have created, updated and stored the initial record in the manufacturer's computer database which is accessible through the Internet (or other network), by for example an HTML browser. Alternatively, the initial record created by the manufacturer could be transferred to another central vehicle asset registry (VAR) that may be operated by another party. In either case, the creator or owner of the initial vehicle asset record, the manufacturer, would grant various access privileges to particular asset records to various individuals and organizations depending on their ownership status or other relevant interest regarding the vehicle. Examples of such interested parties include but are not limited too buyers and potential buyers, owners, insurance, finance, government and law enforcement organizations, marketing/sales, shipping, dealers/distributors, etc.

There would be a master record administrator for each vehicle asset record who would control access rights and all other administrative responsibilities and permissions regarding each record. The administrator would, in the preferred embodiment, be the manufacturer initially, and subsequently the owner of the vehicle. Each particular party or class of organization would have a default set of access privileges that would be set by the manufacturer or owner and which could be modified by the record administrator. That is, the administrator could grant and/or restrict access, retrieval, addition, deletion, and modification, to the records to various parties, including specific and classes of individuals and organizations (i.e., advertising).

For example, the registry provider could establish relationships with an independent service or parts providers (e.g. Jiffy Lube). The service or part providers would have incentive to participate in the GAIR as it would provide them with a centralized service registry, as each repair performed would be entered in the GAIR. The provider could use GAIR to establish comprehensive lists. The secure lists could be used for direct marketing, quality assurance, or to report potential service problems.

Other manufacturers could use the GAIR to more accurately forecast failures and other expected costs (such as would be involved in recalls, warranty “actuarial” analyses, parts and service evaluations, etc.). Sub-components of the multi-vendor vehicle asset could thus be tracked and evaluated.

In one embodiment, the manufacturer or dealer (e.g. GM) would offer this service for free. The auto buyer would be provided with a complete record of the origin and creation of the asset and the access to recording of subsequent relevant incidents during the life of the vehicle. Such incidents include manufacturer issued updates and recalls, dealer scheduled service, accidents and repairs, insurance claims, satisfaction of liens, involvement in criminal activity, transfer of ownership, etc. The owner would be responsible, along with vehicle's other co-interested parties such as insurance, finance, law enforcement agencies, etc. for accessing and updating the vehicle's record. This could be a free or fee for service. It could be offered for a specific time period (e.g. duration that auto is under warranty or service contract) or offered indefinitely to a purchaser as a free service or for some consideration from the purchaser/owner. The vehicle registry service could be transferable or non-transferable (e.g. to a subsequent owner) depending on the interests of the registry service provider.

In one embodiment, owners of the vehicle could be entered to maintain the vehicle record or to use certain maintenance/repair facilities that had access to and would update the vehicle record. For example, the owners may be offered a credit, discounts, reward points, etc. In another embodiment, if the owner used a particular credit card (i.e., issued by Ford or GM) the update of the vehicle record could be automatic.

According to one embodiment, the owner of the vehicle would be alerted automatically through the registry (e.g., via email, pager) of any additions/changes to the asset record, by another party. Such updates could include but are not limited to updates from the manufacturer such as recalls and service notices, advertisements, updates from insurers and financiers, such as change is valuations, payment due notices, premiums due, claim acknowledgment etc.; updates from government bodies, including tax assessment and collection, title applications and issuance, registration, inspection and compliance with other regulations. The owner would similarly modify the vehicle asset record of any changes to the vehicle and the appropriate party would be notified via the registry. Such changes or additions to the vehicle record made by the owner include reporting any change in status of the vehicle, such as the vehicle is “damaged,” “in need of service,” “under repair,” and/or the actual notification of parties including: “filing an insurance claim,” “reporting stolen,” “advertising as for sale,” etc. “Lemon laws” would be readily available with such a thorough record.

The vehicle asset registry would contain individual vehicle asset records which would contain pertinent records regarding all aspects of the vehicle, and which would be a centralized record whereby all interested parties would access the record and communicate information and perform transactions with other interested parties via the record and the network. Because the complete details of the newly manufactured vehicle along with its subsequent ownership, service, damage and repair, finance and legal histories would be contained within the vehicle asset record, there would be no “mysteries” regarding the vehicle. This would be especially important if and when the owner wishes to sell or appraise the vehicle, or in the case that a prospective purchaser wishes to evaluate (i.e. appraise) the vehicle (e.g. used). In either case, each party would know exactly what he was selling, buying, financing, or insuring, because of the vehicle record. This would serve to distinguish the vehicle to purchasers from other “non-registered” vehicles, because when the owner goes to sell or advertise for sale his vehicle, he would offer to prospective purchasers, limited access to the vehicle's record, pointing out certain positive about the vehicle (e.g., its service history).

The prospective purchaser would be able to accurately assess the vehicle, and would automatically receive ownership rights to the vehicle record upon purchase. In one scenario, an owner would simply “trip a flag” in the vehicle record, which would indicate the vehicle was for sale (other options could be specified as well). Because the registry is accessible via the Internet, online interested prospective purchases could identify the asset along with its particulars (down to who made the starter, and when the last oil change occurred), and then directly respond to the offer for sale or bid in the case of an auction.

An authentication and verification system (e.g. security) would prevent unauthorized or illicit modification or deletion of records or their elements. In one embodiment the reporting of accidents and damage, breakdowns or service needs, theft, repair, service, etc. would be mandated though the registry provider. For instance, while the vehicle is under manufacturer warranty, the manufactures, may require the owner (or other party) to report any of the aforementioned events under the penalty of voiding the vehicle (or part) warranty. This would help to insure that the complete history of the vehicle was maintained and accurate.

Below is an exemplary embodiment of the process that would be followed for a vehicle record for a newly produced vehicle, according to one embodiment. This example entails the creation of the master asset record by the manufacturer, and the subsequent transfer of rights/access to this record and updating the record such that the tracking of all “aspects” of the vehicle asset and its component assets (e.g. parts, documents and record, etc.) is accomplished.

Initially, the vehicle manufacture creates logistical plans for purchasing, assembling, shipping, selling, etc. via internal supply chain management (S.C.M.). All (or as many as desired) S.C.M. and other records pertaining to both the manufacturer of the vehicle and the complete vehicle itself would be compiled and placed in the master record (e.g. the pre-sale record compilation would form a manufacture sub-record). This compilation would be performed either during manufacturer or at or subsequent to completion or at both times. A tag (digital or otherwise) attached to vehicle which contains either the master record, a subset of the master record, or just an identifier code for the vehicle such that each unique vehicle asset record would be identifiable by the vehicle identifier, allowing records which are stored and accessed remotely, to be retrieved/accessed via this common vehicle identifier. The vehicle asset record would preferably be stored in a central repository along with other vehicle records. In this embodiment, the manufacturer would provide and maintain the registry/repository, creating the initial master vehicle record at the time of manufacturer as discussed above.

Depending on the circumstance, various access privileges and ownership rights would be transferred to appropriate parties that may access and update the record when needed. Typically, when the vehicle was purchased, access and ownership rights would be given to the purchaser and she could access the records via the Internet. The record could be maintained by the dealer or manufacturer (or other) as a service to the customer, logging all service and other events pertaining to the vehicle in the record within the registry, and notifying the owner and others of the same where appropriate. This registry service then would provide the owner with a centralized and easily accessible updated record of her vehicle and all status changes relating to the vehicle. The owner could access and grant others access to the vehicle's record when appropriate. Communication about particulars of the vehicle, its warranties, service and repair, etc. would be communicated between the owner and dealer or manufacturer via the registry. Examples of other interested parties and their interaction with the asset registry and specific vehicle record are as follows:

(1) Authorized shippers of the vehicles would be granted access to the record for the purposes of identifying the vehicle, its location, and scheduled/arrangement for pickup. The shipper could enter/send/update information related to the vehicle shipping. Delivery receipts and the like indicating or acknowledging change of ownership or responsibility regarding the vehicle would be made by both manufacturer and shipper. A log reflecting the shipping events (i.e. during transport) would also be included. The bonding company of the shipper would also have limited access the vehicle record. When the vehicle was ultimately delivered more updates to the record would be made recording the completion and change in responsibility for vehicle.

(2) Insurance organizations that have a vested interest in a vehicle would be given appropriate access to the registry and record. This would include the originator's, shippers, and receiver's insurance. This would facilitate a seamless transition in insurance coverage, from the manufacturer, to the shipper, to the receiver, in that precise dates and times would be known for when responsibility (both individual and insurance) changes. This would greatly facilitate the filing and payment of claims as well as make the tracking and transactions of insurance coverage more efficient. For instance, in the case of an individual person or corporation who purchases vehicle(s) either for delivery of pickup. In one example the buyer will have notified his insurance company in advance, of the impending purchase, and the insurer will have agreed to insure the vehicle at the time of ownership transfer that would be reflected in the vehicle asset record.

In another example, the insurer would offer the service to buyer of automatic insurance, by virtue of being notified directly by the selling agency (e.g. dealer) through or by way of the vehicle asset record. Alternatively, a type of automatic insurance would be enabled. Automatic insurance would entail the automatic insuring of the vehicle according to and at the time of a change in ownership or other relevant attribute of the asset. The dealer or other seller would preferably offer the service of guaranteeing this automatic insurance as a service plus, such automatic insurance would be the proper notification or arrangement with the insurance company (dealers or buyers) by updating the vehicle record in the registry that ownership change had occurred. The dealer would ask the buyer the name of his insurer, thus allowing the dealer to automatically and directly notify the insurer.

Alternatively, the dealer would make the impending transaction (some but not all details) accessible to a multitude of insurer's who could then bid or make offers to the purchaser to insure the vehicle. This again would be a service to the customer, and perhaps a financial incentive to the seller and insurance agencies.

(3) Banks, sellers, or other types of finance organization that finance vehicles would be granted access. Typically the financing of the vehicle is either arranged in advance by the purchaser, and the “paperwork” completed at the time of sale. Alternatively, the manufacturer or seller offer to obtain financing for the buy (usually through the manufacturer). Similar to what is described above regarding insurance organizations, the same could be true of financing. The seller, could offer as a service to the buyer, to advertise (via the vehicle registry or otherwise) for insurance. This would be essentially the notification via the Internet (e.g. registry) that a particular vehicle was about to be purchased. The finance companies would be able to submit and compete for the customer's business directly through the dealer (or other seller).

The “bidding” finance companies would have access to some information (e.g. credit) regarding the purchaser such that appropriate financing particulars could be generated. Such would be an example of an extension of loan pre-qualification (purchaser already has financing arranged or dealer arranges financing on the spot). In any case there would be a seamless transfer of ownership, payment, promissory notes, liens, etc. For instance, the precise time at which ownership was acquired or changed would be recorded, and thus loans, liens, interest accrual and the like would be well established and documented within the registry. The financing records would added to the master asset record at the time of purchase (i.e. the transaction record would contain the actual transfer record or log of such record and associated financial details).

Alternatively, financing records could be added at any time as deemed appropriate by an authenticated party and all specifics and particulars of the financing would become part of the vehicle record and would be transferred (e.g. via the registry) between relevant parties.

(4) Government/Law Enforcement would be granted access because vehicle purchases involve sales tax, titling, registration (e.g. licenses), verification of insurance, and recording of liens, if any. In one embodiment, the local or appropriate governing body has access to the registry record and the application for and/or completion of the above would be accomplished or at least initiated via the registry (through each vehicle record). For instance, title and tags would be applied for through the registry at, before, or subsequent to the time of purchase. The title, registration (e.g. plates), receipt for tax payment could be sent to the owner later (via electronic means, U.S. mail, etc.). Such applications usually involve identification and verification of liens and insurance, which the government body could do via the registry. Applications and issuance of any special decals or other vehicle licenses or registration could also be accomplished this way. Government could insure that vehicle were properly insured and registered, and that all required inspections and certifications were complied with. Automatic renew notification would also be a capability of the registry.

All of these provide for a centralization of asset records making the continued process much more seamless, and reducing the redundancy and inefficiency involved in the multi-party transaction.

As already discussed, after the purchase is completed, the seller (e.g. manufacture) would agree to maintain the vehicle record and to update everything with which the manufacturer/dealer does regarding the vehicle such as service, repairs, recall, etc. This service could be provided as a part of the warranty or other reason to incentivize the customer. The owner however, would be responsible for ensuring that all other events, and status changes were added to the vehicle record (i.e. the owner controls access to third parties as well). Alternatively, the finance company could perform this role since they too would have a strong ownership interest in the vehicle.

Alternatively, the manufacturer or other (3^{rd} party registry provider) could agree to provide maintenance, updates, and other services regarding the vehicle asset record on behalf of the owner. This would probably be for a fee or other consideration received from the owner. Owners could also put in personal subjective information regarding their experiences with and opinions of the vehicle and its various aspects. This type of subjective information would be used by various parties including potential buyers, the manufacture, and marketing analysts (e.g. Consumer Reports™), the registry itself containing many records, many of the same type of vehicle, which would be analyzed, compiled, and synthesized to provide “review” type information. Manufacturers and other suppliers could use this information to negotiate (e.g. prices, discounts, rebates) based on the actual experiences of the owners. Airbag deployment or other special case activation features would also be recorded in the registry.

Prospective purchasers could be granted access to master vehicle asset record to (via Internet). These could be distributors or direct sale customers (via Internet). There may be particular details about an assembled vehicle, which would be of interest to prospective purchasers. For instance, whether the vehicle was assembled in the U.S. or not, and which parts were manufactured or assembled in the U.S. is important to many people concerned with buy things “made in America.” Also, the specific manufacturer of component parts would be of interest to buyer. Any detail, which would serve to distinguish vehicles and facilitate or assist purchasing decision, would be of great benefit. By including all such details of manufacturer, and allow prospective purchasers to browse the vehicle registry, buyers could choose the best vehicle to suit their needs based on the vehicle asset record. A similar mechanism would be employed which would allow prospective purchasers to “build the vehicle” online, where the purchaser could select desired categories or specific elements and details about the vehicle. Such a filter would allow manufactures to identify an assembled vehicle or construct one from the customer-input specifications.

In other embodiments related to “2^{nd}-hand” vehicles, the vehicle is in existence prior to the record creation, and the master asset record is created subsequent to the creation of the vehicle asset, or this is the case where either the master record was not created at the time of manufacture or was not maintained subsequent thereto. This creation of the “used vehicle” asset could be performed by the manufacturer, owner, or other interested party, and such a record would reside in the registry and be accessible via the Internet as already described. Entry of records could be done by many means which are well know in the art for inserting records into a database, and may include bitmap or other digitization's of non-digital records. Of course, it is envisioned that in the future, as more manufacturers implement the vehicle asset registry concept, more and more used vehicles will come equipped with a vehicle asset record.

The utility and desirability of used car asset records are similar to that of new cars, and would be of potentially more importance regarding the sale of used cars, particularly where the used vehicles have been tracked since their creation or initial sale. Two examples of such “used car tracking” are that of vehicle leasing (i.e. from manufacturer) and rental vehicle disposition (e.g. Avis selling off fleet cars). In both these examples the vehicle asset record could be created at the time of manufacture, which is preferred, or anytime thereafter depending on the particular circumstance.

Another application would be in auto-loan financing markets. For instance, GM offers re-sellers its car loan financing market to balance its financial records. A detailed vehicle record and compliance by the owner with maintaining the record would reduce the risk and increase loan portfolio values. Refinancing with bonds would also be improved because the bonds would receive a higher rating due detail contained within the vehicle asset registry.

In the case of leased vehicle disposition, the manufacturer (or other lessee) leases to another entity a vehicle for a proscribed period of time usually 36-48 months (this may be a new or used vehicle, but in this example, the vehicle is new) After the expiration of this period (or before the expiration in some cases), the lessor returns the vehicle to the lessee (i.e. the dealer/manufacturer), or purchases the vehicle outright. In the former case, the lessee must then dispose of the vehicle. Typically this is done by selling the vehicle either to an individual consumer or another car lot. In the present invention, the newly leased vehicle would have an asset record associated with it, and this record would be maintained by all interested parties as described earlier. In one embodiment, the lessee would either incentivize or require the lessor to have the vehicle undergo periodic manufacturer/dealer authorized service, such that a detailed record of the service history would be contained within the asset record. The manufacturer or lessee would maintain the vehicle asset registry and each individual vehicle record. The lessee, could at their discretion, incentivize or require other information, which may be outside the lessee purview, to be added to the registry by the lessor or other party (the lessor and other parties would also have access to the registry in this case). For those many leased vehicles which are under a service agreement while under lease, the leasing dealer will have (or can obtain) all service, repair and other records of the vehicle.

The leasing dealer may or may not require the lessor to maintain and update the vehicle's asset record regarding all status changes of the vehicle as a condition of the lease. Such a requirement would insure that the asset record would be as complete as possible. Then when these “pre-owned” vehicles were subsequently returned by the lessor to the lessee, they would also have a corresponding asset record, located in the registry, which would assist in the disposition of the vehicle. The vehicle would then be advertised, or otherwise offered for sale (including online auctions via the registry and the like), by the lessee and the offer would include access to the vehicle asset record that would attend the vehicle (via the network or otherwise).

Prospective purchasers (including the original lessors who may want to purchase the vehicle) would have access to the record, thus being better informed regarding the history and condition of the vehicle and potentially more confident regarding the purchase and better able to assess its value (e.g. offer price, warranties, etc.). Similarly the seller (e.g. lessee) would be better able to accurately appraise and price the vehicle and any extended warranty or service plans to be offered. The same utility of accurately valuing the asset would also be readily available to other interested parties, including insurance and finance organizations as well as government tax assessors and regulators (e.g. NTSB, EPA) as discussed previously. A business method for disposing of leased vehicles has been described.

Another case of pre-owned vehicle disposition exists in the rental-car industry. Generally rental car companies such as Hertz and Avis, populate and maintain their fleets by purchasing new vehicles. After the vehicle reaches a given milestone in its life (e.g. age or miles driven), the vehicle is disposed of typically by selling the vehicle in the used car market. There are business which specialize in such disposition, for instance, CarMax and AutoNation, which sell 2^{nd}-hand vehicle obtained from rental-car companies direct to the public. Because these preowned rental cars were all owned by a limited number of rental companies, and because the rental companies typically utilize the manufacturers for service (or other single entities service contract) these vehicles will have the complete service, accident, and repair history associated with them and actually owned by the rental-companies.

Alternative servicing and repair strategies could also be employed, however the fact that each company currently maintains a record of each vehicle in the fleet, implementation of an extended vehicle asset registry would be relatively straightforward. Each rental company would track its own vehicles' history, including service, repair, location, and other pertinent aspect about the vehicle, storing this data in the vehicle record. The rental companies would maintain or compile these records into a vehicle asset record to be transferred with the vehicle upon sale (or advertisement for sale), or alternatively, the 3^{rd} party disposer (e.g. AutoNation) would receive the records and compile them for presentation to potential purchasers over the Internet.

In one embodiment, the rental company will maintain its own proprietary vehicle registry. In another, the manufacturer will provide the service of the vehicle registry and assist in updating and maintaining each vehicle's record on behalf of or in conjunction with the rental company. In still another case, a third party offers such a registry service to the car-rental company. In either of these cases, the rental company maintains (or has maintained) the records of the vehicle, such that at the end of the “rental-life” of the vehicles, their will exist a current vehicle record (preferably stored in a registry accessed via the Internet) which will be associated with each vehicle and facilitate disposition of the vehicle, either to a re-seller, or directly to a consumer.

Another embodiment would be that of a used car lot, independent or dealer, which received or bought the 2^{nd} hand vehicle from another party and which did not have direct access to the records relating to the life of the vehicle. The lot could attempt to solicit as much of the vehicle records as possible from the previous owner. The used car lot would compile these records into the used vehicle's asset records, and advertise the vehicle via the Internet or other medium, using the assembled asset record as evidence of the vehicle's relative worth. The entity which sells or trade-ins their vehicle to the lot would then also have an incentive to maintain the records related to the vehicle as it would fetch a higher price due to the confidence of the purchaser, and in the case of the used car lot, the ability to garner a higher price for the vehicle because of the asset record.

Still another embodiment is that of individual car owners who want to sell their used vehicles. If they were to offer an asset record detailing the history of the vehicle, the vehicle would potentially be more attractive to prospective buyers. A internet website, a .com for instance, could provide a service whereby used car sellers would provide the vehicle records or a compilation of such, and the vehicle would be advertised on the WWW along with any pertinent records provided by the seller. Prospective buyer could search for vehicle and be able to more accurately assess the value of the vehicle, and would have the ability to differentiate vehicles based on each vehicle's record.

For existing assets such as these, which are those already purchased before “registration at production/sale” is implemented or which were not registered at manufacturer, the. asset record can always be created by owner (or other interested parties). Such a web-service as already described would assist the owner in creating the record and adding the appropriate records. This would be particularly useful if the owner wished to sell the vehicle, the web service providing the creation of the asset record, and the advertising for sale or auction of the vehicle. This service would be provided for a fee, contingency or some other consideration.

Examples of third party interests include, but are not limited to, potential buyers who could the search registry for vehicles for sale; marketing researchers who could extract profiling data; parties wishing ownership ‘review’ information of particular vehicles; parties requiring verification of assertions or advertisements made by owners that could be substantiated by the vehicle record. “Blue Book” values could then be made much more accurate and contain much more detail and specifics regarding the vehicle. The overall issue of product liability would also be more easily tracked, maintained, and predicted via such a registry.

The use of the Global Positioning System (GPS) to track the location of asset (vehicle or otherwise), and automatic updating of such position information in the registry would facilitate shipping arrangements in that the location of the asset would always be known, thus the scheduling of pick-up and delivery could be accomplished in a more efficient and seamless way. Owners, financiers, insurers, and law enforcement would always know where asset was located because its position would be updated via the registry (this could be accomplished via a wireless Internet connection). Thus, if an asset such as vehicle was involved in an accident, service and emergency personnel would be notified via the registry and know where to find the vehicle. Similarly, if the vehicle was wanted in connection with criminal or other activity, it could be easily located. Also, if repossession was warranted, the vehicle could be located. This general concept of a vehicle asset self-reporting its location and status (i.e. its condition such as out-of-gas or in need of a particular service), by wireless or any other means could be applied to other assets as will be evident to those skilled in the art.

As will be evident to those skilled in the art, the above asset registration and tracking, as described for vehicles, is equally applicable to all types of assets, particularly, multi-vendor assembled assets for which the individual records and other histories of the component parts are also maintained in the registry. Examples of other multi-vendor assets include both made-to-order and made-to-stock products and services.

For instance, computer systems fit both categories. Computers are assembled for sale via distributors in which case they are made to stock and a limited number of models are available (per manufacturer). Computers can also be made to order, for instance by Dell computer or gateway. Asset records and a computer asset registry, for instance, would have provided multiple benefits to manufacturers, consumer, and other parties in similar ways as that of the vehicle asset registry. A manufacturer, distributor, or other interested party would provide such a registry service. For instance, Dell would allow customers to “build” their own computer online, and in the process an asset record would be created detailing the individual parts, assembly details, manuals, warranties, services agreements, etc. Alternatively, Dell (or distributor/retailer or other 3^{rd} party) would construct the record and transfer the record with the computer asset (preferably by granting registry access through the Internet).

This record would be transferred to the purchaser (i.e. the owner would have access to it via the Internet), and could be used by the owner, manufacturer or others to facilitate any transactions (or other attributes) regarding the computer asset.

The owner would be able to notify interested parties and vice versa via the registry as described earlier herein. Appliances, electronic components and systems, and digital devices represent a small fraction of multi-vendor assets to which the asset registry and tracking system can be applied.

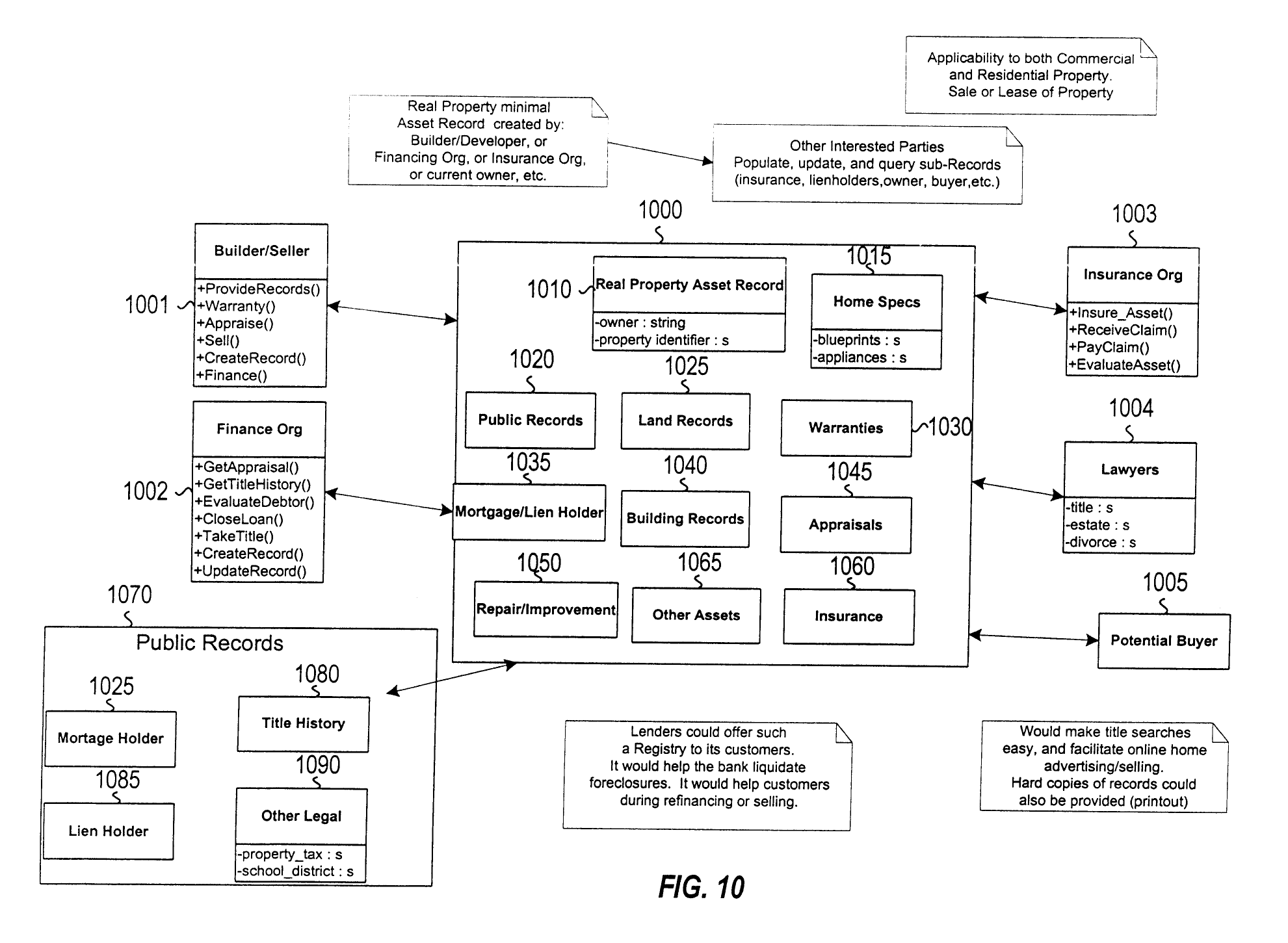

A second specific industry that could use the GAIR is the real-estate industry (i.e., property). FIG. 10 illustrates an exemplary real estate master record 1000. Entities that may write and/or read data to the master record 1000 include, but are not limited to, builder/seller 1001, finance organization 1002, insurance organizations 1003, lawyers 1004 and potential buyers. The master real-estate record may include an asset record 1010, home specifications 1015, public records 1020, lien records 1025, warranties 1030, mortgage/lien holders 1035, building records 1040, appraisals 1045, repair/improvements 1050, other assets 1055, and insurance 1060. The public records 1020 may be transferred into the master record 1000 from a public record database 1070 that includes mortgage holder 1075, title history 1080, lien holder 1085 and other legal data 1090.

In one embodiment of the current invention, the real estate GAIR may include the registration of a newly created real property asset. Such newly created assets would include all new construction and developments of all zoning types (e.g. residential, commercial, agriculture, etc.). Examples of such construction and newly created real property include single and multi-unit residential dwellings, business parks and their associated units, shopping centers and “malls”, farmland and buildings, government buildings, hospitals, transportation depots, and manufactured homes. In a preferred embodiment, the record would ultimately contain all information related to property development including permanent household assets such as appliances.

Real estate developers often develop subdivisions in which a land parcel is divided into lots, and then the lots are sold to individuals. The sale of the lots can be independent of or in conjunction with the building of a house on the lot. The developer, financier, or the like will create property records and store these in a central registry. For instance, a developer begins by purchasing a parcel of undeveloped land. At this point the developer will have all legal information related to the property. When the developer subdivides the land into lots, a property asset record would be created for each lot, and this lot property record would serve as the initial master record for that piece of property. Because the developer in effect created each new lot, he would have all pertinent records of the “newly created” property. The property record would contain all information the record creator desired, and could include such things as the survey of the lot and the survey of the subdivision, land, aerial or satellite photographs, utility information, percolation and environmental tests, deeds, easements, zoning and restrictions, nearest schools, churches and stores, financial and insurance information, purchase or sale price, etc. The developer would store these records, preferably in a database, and provide Internet access to these records to any party who the record holder/maintainer desired. Such parties might include purchasers, realtors, contractors and lien holders, insurance and finance organizations, government and law enforcement. The property records would be stored in an property asset registry.

As described elsewhere in this document, such interested parties would centrally access property records via a computer network interface and have certain privileges based on their interest. For instance, application/verification for insurance coverage and claim filings would be effected via the registry, the insurer having access to the pertinent property attributes in order to underwrite a policy or evaluate a claim, the owner applying for and providing required information to the insurer via the registry. The insurance information would become part of the property record. Similarly, financing of the property would be accomplished online via the registry. The bank or mortgage lender would have direct access to many aspects of the property, such that appraisals and other loan underwriting information extracted from the property asset record. The legal information regarding the titles, liens, surveys, zoning, etc., would all be in the registry record. Because the property is “newly created” the title history of this lot may begin at the time is was created in which case the property record would also be the title record. This fact would be exploited subsequently because title searches and the like could be done via the registry.

As the property was further developed the property record would be updated by the developer (or other) to reflect these improvements. Such improvements include roads, utilities, water and sewer, and buildings. By adding/updating records corresponding to the improvements, the development or evolution of the real estate asset is chronicled. An example of a developed property is a new home (turn key) which is ready to be sold or leased. The property record at this point would contain not only details on the land, but on the buildings and other improvements. Such details may include, blueprints, designs and all building specifications, construction materials list, contractor warranties, appliance asset records and house components, warranties, and any other information desired.

In one embodiment, the developer advertises via the Internet, the properties by allowing the selected and limited viewing of the property records. Buyers would have access to selected information on properties via a web browser. For instance, a buyer would not only have a picture, but he would know the paint or shingle manufacture and their exact color and type. The type and specifications of the appliances, flooring, and insulation are just a few examples of what would be accessible by potential buyers through the registry. Buyers would distinguish and differentiate properties via the property registry. Alternatively, the developer or creator/maintainer of these records would provide them to a third party (e.g. Realtor) for advertisement or other dissemination purposes.

When ownership of a property changed the property record ownership would also change. If the developer sold a home, the ownership and administrative rights of the record would be transferred to the buyer. Of course, the mortgage company may also have ownership interest in the property record. The new owner would be able to establish insurance coverage, file claims, pay taxes, establish utility service, request service for the home (e.g. plumbing, carpentry) etc., all via the registry. Because all the appliances and such like come with the home, these will have been listed in the property record. For an appliance or other device that had a self-reporting capability (e.g. was part of a communications network), this device record would be automatically added/removed (e.g. by its own operation) to the property record when the device was added to/removed from the property (this could occur at any time).

If owner has a question or problem with an appliance, service and/or warranty claim would be readily obtained, because the owner would have the specs of the appliance that would facilitate repair. This would require an interface with the appropriate parties as can be easily accomplished as evident to those skilled in the art. The owner would now maintain the registry (or registry provider would provide such as service to the property owner) in that any improvements or repairs, legal or other changes occurred which affected the objective or subjective value of the home. Appraisals and other value related functions and transactions would be performable via the property record.

When an owner wished to sell his property, he would merely have to label his property as for sale by way of the property record in the registry. The registry itself could serve as a repository for “home for sale” or alternatively, a 3^{rd} party “realtor” or would link to those “for sale” properties in the registry. Also, owners may allow at their discretion, limited access to their property record by any interested party for whatever reason.

In the more general case, for all properties including existing or “older” properties, a service would be offered to owners, to compile all or as many as desired of the owned properties records, and store them in a registry/repository. In one embodiment, the service creates a master record, and allows the owner to input various relevant records regarding the property, thus building a complete property record. This could be done via a web browser, or in any other way as described elsewhere in this document (c.f. electronic file cabinet). In another embodiment, the service performs the research and records acquisition on behalf of the owner and stores them in the registry in the master property record. The owner would own and control his own property asset record, updating it or having others update it, notify others and receive notification from others (e.g. service due, taxes due, etc.) and could use it for many purposes including advertisement and sale, as described above.

Another service provided by the property asset record and registry would be the notification of utility companies and establishing accounts with such (i.e. over the Internet via the property record). An interface between the utility companies would exist and a property owner could request services and pay for services via the registry by simply providing the utility provider, through the interface, the property record identifier.

The utility company would then be able to access the property record, determine its location, service needs (based for instance on home specifications), billing party, etc. Billing would also be performed via the registry. Examples of such utilities are electric, telephone, cable, gas, water, sewer, and waste management. In one embodiment, the utility provider would retain ownership of certain assets (e.g., motors and meters), that may provide network-based readings and other monitoring activity. When the property ownership was transferred and reflected in the registry, the responsibilities for the various utilities and their expenses (including credits) would be known and could be seamlessly (e.g. automatically) updated.

In one embodiment, the primary goal of property registry and property records is to track the ownership of the property asset and the value of the asset. Such ownership information is particularly complex and also critical to establish clear title or otherwise “remove the cloud” on title. Interested parties such as mortgage lenders (public, private. individuals), ‘mechanics’ and other home service providers, property owners, and taxing authorities may have an ownership interest in the property at one time or another. All of these are important in property transfers including sales, creditor and ‘last will’ estate dispositions. For instance, money borrowed using the property as collateral (i.e. 1^{st}, 2^{nd}, 3^{rd}, mortgages), mechanic's liens, tax liens and the like all give 3^{rd} parties (other than the owner) an interest in the property. These types of information would be recorded in the registry, the particular property records being updated if and when such ownership interest occur or change.

Moreover, status changes and transactions that tend to affect the value of the property would also be maintained current in the registry record. Such changes to the property would include, among others, appraisals, change in insurance coverage, damages and repairs, new appliances, additions and renovations (including the associated building permits), and refinancing. These updates would be performed and the property record maintained by the “owner” of the property, or alternatively could be accomplished by other parties, such as the appraiser, insurer, financier, mechanic (e.g. plumber) appliance supplier, who will have access to the registry. Such changes may affect the value of the asset in which case insurers, appraisers, and assessors would be automatically notified via the registry such that the asset can be reassessed in light of the changes to the asset. The property asset record, stored in the property asset registry would be the “record of record” in that it would track and contain the most current status of the attributes of the property, particularly financial, ownership, and value related information.

In another embodiment, manufacturers of mobile/manufactured homes would create an home asset record, similarly to that described for vehicles and other multi-vendor components, containing all details of construction and of the components of the structure itself and of the accessories (e.g. appliances and furnishings). The initial record would be independent of specific property, but would be updated to include the real property information (owned or leased) when the manufactured home was moved to a property.

The value, utility, and methods by which such a record would be used by various interested parties have already been discussed.

In other embodiments, a property asset record service would be offered, by for instance, a mortgage company, an insurance company, or by a developer/seller as an incentive for the purchaser to obtain financing through that finance company, to obtain insurance through that insurance company, or to purchase the property from that seller, respectively. Other parties such as realtors and title companies could also offer the service.

A single and complete service would provide a full, and preferably complete, range of services regarding property purchases. Services involved in property acquisition may include, among others, identifying the property(ies), negotiating a contract, obtaining financing (which includes title searching and insurance, appraisal, surveys, closing attorneys, etc.), obtaining inspections, percolation and environmental tests, and eventually, establishing the various utility services and creating Internet accounts for such. Such a service would create an initial property asset record, adding more detail such as the advertising, contract, and closing on the property proceeded, and the record would thus contain the evolving details of each process in the sale of the property. This record would be made available to the purchaser prior to closing such that the purchaser could track the status of various events, and transactional details could be performed via the registry over the Internet. The record would be “given” to the purchaser after closing, or alternatively could be maintained by the service provider. The value of such a record has already been described, and thus the service of property asset record creation and registry storage would be an additional incentive to use such a “do-all” property service.

It is clear that although a service providing all of the above services is preferable, other services offering a limited subset of the above services or others, and establishing a “property” record corresponding to such service are also potential business applications.

Example real estate oriented services that may provide as an additional service, the creation of the property record, are appraisal and inspection services, and finance or mortgage lenders.

In an example embodiment, the mortgage lender (e.g. a bank) provides the property asset record registry creation/maintenance service to the purchaser, as an incentive for using the lender to finance the property. Using the registry (via the Internet) the lender would offer additional services such as periodic low-cost or free appraisals, and reduced cost re-financing of the property. Such services would incentivize customers to use that particular lender. Another service offered by the lender in association with and by way of the property registry, would be the automatic payment of regularly scheduled bills or other payments due on behalf of the owner. Such payments would include mortgage, insurance and utility bills. Of course, these services could also be provided on behalf of the owner's local bank, but such services by the property lender would also provide incentive for the purchaser to utilize the lender for all other banking needs.

Advertising by interested parties wishing to establish business or other relationships with owners could be selectively delivered based on registry profiles. For example, targeted soliciting to owners whose property values exceeded a certain threshold value and/or who had significant equity in the property might be targeted for investment opportunity solicitations. Also, demographic information could be extracted from the registry such that community profiling could be done. For instance, when a buyer is interested in a particular property, he would be able to determine who his neighbors would be/are (e.g. names, income, family information, etc.)

In another example embodiment, a realtor or real estate broker would offer services to buyers (e.g. a buyer's agent) of compiling and generating or assisting in generating a property asset record for the home or homes the buyer's were interested in. This would provide the buyers with various information about the properties, the buyers would then be able to better evaluate the property and make purchasing and offer decisions. These records would preferably be stored in a computer database accessible via the Internet. Online negotiation could also be performed via the registry record between buyer and seller directly or through broker. When the purchase was made, the realtor or service would transfer ownership and maintenance of the record to the purchaser, or alternatively, agree to maintain or help maintain the property record. This service may be offered for a fee or as an incentive for the purchaser to use the realtor service, which provided the property record.

One example of an incentive is simply the creation and/or maintenance of a property record in exchange for utilizing the “buyer's agent” service. Other incentives include periodic appraisals and updated market analyses. Another incentive which could be given by the realtor is to provide a proprietary record to the purchaser, such that if the purchaser decided subsequently to sell (i.e. list for sale) the property, the owner would have agreed to use that same realtor to list the property, or alternatively, to utilize that same realtor when advertisement and sale of the property relies on the property record created by the realtor. The realtor/record service may offer a commission or flat rate discount for acting as broker for the subsequent sale due to the fact that the property record is already in existence, and thus details about the property would be up-to-date and the listing broker would have less work to perform regarding advertising the property.

In another embodiment, a title company registers the title search records and insurance policy in an asset record as a service to its customers. Free or reduced-cost title searches and insurance would be provided where such records existed on a property for which a title search or insurance was needed.

Another embodiment of the real estate GAIR covers household asset inventory registration. Whatever is bought, or is part of the property (e.g. Home), is registered and included in a master household inventory record. Registration information per item would include manufacturer, model and serial number, date of purchase, etc. Each item would be registered with the manufacturer, warrantor, service (i.e. Help) provider, via the registry and such registration information would be stored in the registry. This registration could be accomplished via the “automated registration at purchase” or by other methods including owner registering such assets in a household inventory record through a 3^{rd} party provider or through his insurance company.

Alternatively, an insurance company could offer a service of providing such a registry and record. As described elsewhere herein, this property asset inventory record would be used to establish and verify ownership and asset identification for such entities as insurance companies when underwriting a policy or filing a claim, and law enforcement when tracking a stolen item. Additionally, in the case of “internet enabled appliances,” connected to the “home network”, this may allow for an “update registry” function/mechanism that would be part of the device, which would result in automatic update of the registry by virtue of being on (or added to or removed from) the “property/home network.”

In addition to the services of particular entities such as service, repair, and “help desks”, certain information such as online manuals, each specific to the asset, would be reached or obtainable via the registry record. For example, a homeowner purchases a stereo system and obtains an asset record for the stereo. The owner would be able to directly access the instruction manual related to that asset without having to search for them, simply because the asset was registered with enough identifying information to locate the instructions. The instructions would be on the manufacturer's web-site, provided as a service to its customers, or alternatively would be provided by third party broker.

If the stereo were to break, the owner would simply enter into the asset record the specific problem or the symptoms. A request for service would automatically be generated, and the owner would not have to specify the item's identification, as it would be automatically generated from the record itself and forward to the appropriate party. Such appropriate party could be a part of the asset record itself (e.g. manufacturer), or could be determined by another 3rd party or algorithm (i.e. artificial intelligence) based on the details in the asset record and in the “request for service” entered by the owner.

Also, the manufacturer who would be able to notify/update the owner via the registry of any new information (e.g. change in contact information, expiration of warranty, etc.)

Although this invention has been illustrated by reference to specific embodiments, it will be apparent to those of ordinary skill in the art that various changes and modifications may be made that clearly fall within the scope of the invention. The invention is intended to be protected broadly within the spirit and scope of the appended claims.

What is claimed:

1. A method for recording information related to assets throughout a life cycle of the asset, the method comprising:
identifying the asset to be entered into an asset registry;
assigning a unique identifier to the asset;
recording the information related to the asset in the asset registry, wherein the information is associated with the unique identifier;
categorizing the information related to the asset into multiple attributes;
managing read and write privileges to the asset registry for various entities; and
providing access to the attributes to the various entities that have an interest in the asset, wherein an entity having write privileges for a first attribute of the asset can write data related to a change in the first attribute of the asset to the asset registry, and an entity having read privileges for a second attribute of the asset can read data related to the second attribute.

2. The method of claim 1, wherein the information is being recorded for an entire life cycle of the asset.

3. The method of claim 1, wherein the information is being recorded for a portion of a life cycle of the asset.

4. The method of claim 1, wherein the asset includes multiple components.

5. The method of claim 4, wherein the information related to the asset includes data corresponding to each component part.

6. The method of claim 5, wherein each component part can be considered to be an asset in and of itself.

7. The method of claim 1, wherein the asset is a multi-vendor asset.

8. The method of claim 7, wherein the information related to the asset includes data corresponding to each sub-asset and data identifying each vendor providing a sub-asset.

9. The method of claim 1, wherein the information related to the asset includes data identifying a manufacturer of the asset.

10. The method of claim 1, wherein the information related to the asset includes data identifying a current owner of the asset.

11. The method of claim 10, wherein ownership of an asset can be of varying nature, such as right to publication, right to distribution, or right to limited uses.

12. The method of claim 10, wherein ownership of the asset can be of a shared nature, such as joint ownership or partnership rights.

13. The method of claim 1, wherein the information related to the asset includes documents associated with the asset.

14. The method of claim 13, wherein the documents may be parts lists, warrantees, service agreements, user manuals, insurance, or specifications.

15. The method of claim 13, wherein the documents are digital images of original paper documents.

16. The method of claim 13, wherein the documents are authenticated digital originals.

17. The method of claim 1, wherein the asset is a physical asset.

18. The method of claim 1, wherein the asset is a financial asset such as stock certificates, certificates of deposits, mortgages, options or other forms.

19. The method of claim 1, wherein the asset is a digital object.

20. The method of claim 19, wherein the digital object is a copyrighted asset.

21. The method of claim 20, wherein the copyrighted asset is an audio program, video program, or a work of art.

22. The method of claim 1, wherein the entities having an interest in the asset communicate with the asset registry.

23. The method of claim 22, wherein the entities communicate with the asset registry over a network.

24. The method of claim 23, wherein the network is the Internet.

25. The method of claim 1, wherein the unique identifier may be an already existing designator or may be newly created.

26. The method of claim 1, wherein the asset registry includes one or more databases.

27. The method of claim 1, wherein the current owner manages the read and right privileges.

28. The method of claim 1, further comprising storing data related to any change in status of the asset.

29. The method of claim 28, wherein a transaction would effect a change in the status of the asset.

30. The method of claim 29, wherein the transaction may be anything that effects rights, values or ownership of the asset.

31. The method of claim 29, wherein the transaction may be buying, selling, repairing, appraising, insuring, financing, registering, maintaining, modifying, or disposing of.

32. The method of claim 29, wherein the transaction may involve electronic financial payments.

33. The method of claim 32, wherein the transaction may involve credit cards, debit cards, or other consumer credit systems.

34. The method of claim 32, wherein the transaction may involve new or future methods such as though that may rely on digital wallets, smart cards or other embedded technologies.

35. The method of claim 32, wherein the transaction may involve business to business exchanges that rely on commercial credit transactions such as wire transfers, Electronic Data Interchange technologies or other commercial credit systems.

36. The method of claim 29, wherein one transaction may change the status of one or more assets.

37. The method of claim 29, wherein the status of the asset may be affected by one or more transactions.

38. The method of claim 29, wherein entities are involved in the transactions.

39. The method of claim 38, wherein the entities may generate documents in support of the transaction.

40. The method of claim 38, wherein the entities may be required to produce documents prior to participating in a transaction.

41. The method of claim 40, wherein the documents required for participating in a transaction are identification documents.

42. The method of claim 41, wherein the documents required for participating in a transaction may further include insurance, finance, ownership, or registration.

43. The method of claim 38, wherein each entity may be involved in one or more transactions.

44. The method of claim 38, wherein each transaction may have involvement from one or more entities.

45. The method of claim 1, wherein the various entities include organizations, individuals and partnerships.

46. The method of claim 1, wherein the various entities include manufacturers, distributors, wholesalers, retailers, buyers, owners, law enforcement, insurance, and financial.

47. The method of claim 29, wherein documentation may be generated in support of the transaction.

48. The method of claim 47, wherein the documentation includes purchase orders, maintenance receipts, appraisals, inspections, and registrations.

49. The method of claim 47, wherein each transaction may have one or more associated documents.

50. The method of claim 1, wherein the read and write privileges can be changed during the life cycle of the asset.

51. The method of claim 50, wherein an owner of the asset manages the read and write privileges.

52. A system for recording information related to an asset and providing access to the information to interested parties throughout a life cycle of the asset, the system comprising:
a plurality of entities having an interest in the asset;
an asset registry for recording information related to the asset;
categorizing the information into various attributes;
managing read and write privileges to the plurality of entities having an interest in the asset;
providing access to the various attributes to the plurality of entities, wherein an entity having write privileges for a first attribute of the asset can write data related to a change in the first attribute of the asset, and an organization having read privileges for a second attribute of the asset can read data related to the second attribute; and
a network providing a link between the plurality of entities and the asset registry.

53. The system of claim 52, wherein the asset registry includes one or more databases.

54. The system of claim 52, wherein the network is the Internet.

55. A system for recording information related to an asset and providing access to the information to interested entities, the system comprising:
means for recording information related to the asset;
means for categorizing the information into various attributes;
means for managing read and write privileges to entities having an interest in the asset; and
means for providing access to the various attributes of the asset to the entities having an interest in the asset, wherein an entity having write privileges for a first attribute of the asset can write data related to a change in the first attribute of the asset, and an organization having read privileges for a second attribute of the asset can read data related to the second attribute.

56. The system of claim 55, wherein the means for recoding information records information related to any change in status of the asset.

57. The system of claim 55, wherein the means for recording information records information related to transactions that have an effect on the asset.

58. The system of claim 57, wherein the means for recording information records documents related to the transactions.

59. The system of claim 57, wherein the means for recording information records information related to the entities participating in the transactions.

60. The system of claim 55, wherein the means for recoding information records information related to the entities having an interest in the asset.

61. The system of claim 57, wherein the means for providing access to the various attributes of the asset includes means for authenticating the entity desiring access.

62. The method of claim 1, wherein various entities always have read privileges.

63. The method of claim 1, further comprising authenticating an entity's identity prior to providing read or write access.
